(19) United States
(12) Patent Application Publication
(10) Pub. No.: US 2024/0117106 A1
(43) Pub. Date: Apr. 11, 2024

(54) POLYESTER COMPOSITIONS COMPRISING TETRAMETHYL CYCLOBUTANEDIOL AND 1,4-CYCLOHEXANEDIMETHANOL HAVING AN IMPROVED CATALYST SYSTEM COMPRISING TITANIUM AND ZINC

(71) Applicant: Eastman Chemical Company, Kingsport, TN (US)

(72) Inventors: Brian Alan Schaefer, Kingsport, TN (US); Kate Elizabeth Allen, Jonesborough, TN (US)

(73) Assignee: Eastman Chemical Company, Kingsport, TN (US)

(21) Appl. No.: 18/257,678

(22) PCT Filed: Dec. 16, 2021
(86) PCT No.: PCT/US2021/063666

§ 371 Date: Jun. 15, 2023

Related U.S. Application Data
(60) Provisional application No. 63/199,303, filed on Dec. 18, 2020.
(60) Provisional application No. 63/199,304, filed on Dec. 18, 2020.
(60) Provisional application No. 63/199,305, filed on Dec. 18, 2020.
(60) Provisional application No. 63/199,306, filed on Dec. 18, 2020.
(60) Provisional application No. 63/199,308, filed on Dec. 18, 2020.
(60) Provisional application No. 63/199,309, filed on Dec. 18, 2020.
(60) Provisional application No. 63/199,310, filed on Dec. 18, 2020.

(51) Int. Cl. C08G 63/183; C08G 63/83; C08L 67/02

(52) U.S. Cl. CPC C08G 63/183; C08G 63/83; C08L 67/02

(57) ABSTRACT

A polyester composition comprising: (1) at least one polyester which comprises: (a) a dicarboxylic acid component comprising: (i) about 70 to about 100 mole % residues of terephthalic acid or esters thereof; (ii) about 0 to about 30 mole % of aromatic and/or aliphatic dicarboxylic acid residues having up to 20 carbon atoms; (b) a glycol component comprising: (i) about 10 to about 60 mole % of 2, 2,4,4-tetramethyl-1,3-cyclobutanediol residues; (ii) about 40 to about 90 mole % residues of 1,4-cyclohexanedimethanol; (iii) optionally, residues of at least one modifying glycol; wherein the total mole % of the dicarboxylic acid component of the final polyester is 100 mole %; wherein the total mole % of the glycol component of the final polyester is 100 mole %; and (2) residues comprising titanium atoms and zinc atoms, and less than 30 ppm, or less than 20 ppm, or less than 10 ppm, or less than 5 ppm, or less than 2 ppm, or from 0 to 30 ppm, or from 0 to 20 ppm, or from 0 to 10 ppm, or 0 ppm of tin atoms.

### FIELD OF THE INVENTION

The present invention relates to polyester compositions made from residues of terephthalic acid or ester(s) thereof, 2,2,4,4-tetramethyl-1,3-cyclobutanediol (TMCD) and 1,4-cyclohexanedimethanol. The polyester compositions can be catalyzed by a catalyst system comprising titanium and zinc atoms, which can result in good TMCD incorporation, improved color, and reactivity to achieve desired IV over the compositional range.

### BACKGROUND OF THE INVENTION

Tin (Sn) based catalysts are typically the most efficient at incorporating TMCD into a polyester (Caldwell et al. CA 740050, and Kelsey et al., Macromolecules 2000, 33, 581). However, tin based catalysts typically produce a yellow to amber colored copolyester in the presence of EG, e.g., see Kelsey, U.S. Pat. No. 5,705,575, and Morris et al., U.S. Pat. No. 5,955,565.

Titanium (Ti) based catalysts are reported to be ineffective at incorporating 2,2,4,4-tetramethyl-1,3-cyclobutanediol (TMCD) into a polyester (Caldwell et al. CA 740050, Kelsey et al., Macromolecules 2000, 33, 5810).

US Patent Application No. 2007/0142511 discloses that polyesters with a glycol component comprising TMCD and EG, and optionally, certain levels of CHDM, can be prepared with titanium based catalysts. It indicates that TMCD incorporation can be improved by use of tin based catalysts in addition to titanium based catalysts. It further indicates that the color of these copolyesters can be improved with the addition of certain levels of phosphorus containing compounds. This publication discloses a wide compositional range with a glycol component comprising: (i) about 1 to about 90 mole % TMCD residues; and (ii) about 99 to about 10 mole % EG residues. However, whenever relatively high levels of EG were present, the catalyst system required increasingly significant amount of Sn.

There is a commercial need for a polymeric material with a combination of properties making it desirable for injection molding, blow molding, extrusion, and thermoformed film and sheet applications including a combination of one or more, two or more, or three or more, of good notched Izod impact strength, good inherent viscosities, good glass transition temperature (Tg), good flexural modulus, good tensile strength, good clarity, good color, good dishwasherability, good TMCD incorporation and good/improved melt stability.

### SUMMARY OF THE INVENTION

It has been found that significant amounts of TMCD can be incorporated into a polymer when DMT, TMCD, and CHDM are catalyzed with at least one tritium catalyst and at least one zinc catalyst. It has also been found that a catalyst system containing a combination of titanium and zinc catalysts can provide a combination of one or more, two or more, or three or more, of good notched Izod impact strength, good inherent viscosities, good glass transition temperature (Tg), good flexural modulus, good tensile strength, good clarity, good color, good dishwasherability, good TMCD incorporation and good/improved melt and/or thermal stability.

In certain aspects, a catalyst combination of titanium and zinc can result in a copolyester with good TMCD incorporation and reactivity to achieve the desired inherent viscosity over a broad compositional range that includes but is not limited to: (a) a dicarboxylic acid component comprising: (i) 70 to 100 mole % terephthalic acid and/or dimethyl terephthalate residues; and (ii) about 0 to about 30 mole % of aromatic and/or aliphatic dicarboxylic acid residues having up to 20 carbon atoms; and (b) a glycol component comprising about 10 to about 50 mole % 2,2,4,4-tetramethyl-1,3-cyclobutanediol (TMCD) residues and about 50 to about 90 mole % 1,4-cyclohexanedimethanol residues (CHDM), based on the glycol component totaling 100 mole % and the diacid component totaling 100 mole %.

It is unpredictable that the polyesters and/or polyester compositions of the invention would have these properties when using a catalyst system to prepare them that does not require the use of a tin catalyst.

In one aspect, the polyesters and/or polyester compositions of the invention can comprise residues of TMCD in the amount of from about 10 to about 55 mole %, or from about 10 to about 50 mole %, or from about 10 to about 45 mole %, or from about 10 to about 40 mole %, or from about 15 to about 55 mole %, or from about 15 to about 50 mole, or from about 15 to about 45 mole %, or from about 15 to about 40 mole %, or from about 20 to about 55 mole %, or from about 20 to about 50 mole %, or from about 20 to about 45 mole %, or from about 20 to about 40 mole %, or from about 20 to about 35 mole %, or from about 20 to about 30 mole %, or from about 25 to about 55 mole %, or from about 25 to about 50 mole %, or from about 25 to about 45 mole %, or from about 25 to about 40 mole %, or from about 30 to about 55 mole %, or from about 30 to about 50 mole %, or from about 30 to about 45 mole %, or from about 30 to about 40 mole %, or from about 30 to about 35 mole %, or from about 35 to about 55 mole %, or from about 35 to about 50 mole %, or from about 35 to about 45 mole %, based on the total mole percentages of glycol residues in the final polyester equaling 100 mole %.

In one aspect, the polyesters and/or polyester compositions of the invention can comprise residues of TMCD in the amount of from about 10 to about 50 mole %, or from about 20 to about 50 mole %, or from about 20 to about 40 mole %, or from about 25 to about 50 mole %, or from about 30 to about 50 mole %, or from about 30 to about 45 mole %, based on the total mole percentages of glycol residues in the final polyester equaling 100 mole %.

In one aspect, the polyesters and/or polyester compositions of the invention can comprise CHDM residues in the amount of from about 45 to about 90 mole %, or from about 50 to about 90 mole %, or from about 55 to about 90 mole %, or from about 60 to about 90 mole %, or from about 45 to about 85 mole %, or from about 50 to about 85 mole, or from about 55 to about 85 mole %, or from about 60 to about 85 mole %, or from about 45 to about 80 mole %, or from about 50 to about 80 mole %, or from about 55 to about 80 mole %, or from about 60 to about 80 mole %, or from about 65 to about 80 mole %, or from about 70 to about 80 mole %, or from about 45 to about 75 mole %, or from about 50 to about 75 mole %, or from about 55 to about 75 mole %, or from about 60 to about 75 mole %, or from about 45 to about 70 mole %, or from about 50 to about 70 mole %, or from about 55 to about 70 mole %, or from about 60 to about 70 mole %, or from about 45 to about 65 mole %, or from about 50 to about 65 mole %, or from about 55 to about 65 mole %, based on the total mole percentages of glycol residues in the final polyester equaling 100 mole %.

In one aspect, the polyesters and/or polyester compositions of the invention can comprise CHDM residues in the amount of from about 50 to about 80 mole %, or from about 60 to about 80 mole %, or from about 50 to about 75 mole %, or from about 50 to about 70 mole %, or from about 55 to about 70 mole %, based on the total mole percentages of glycol residues in the final polyester equaling 100 mole %.

In one aspect, In one embodiment, the polyesters and/or the polyester compositions of the invention can comprise 10 to 50 mole % of residues of TMCD and 50 to 90 mole % of residues of CHDM; or 10 to 45 mole % of residues of TMCD and 55 to 90 mole % of residues of CHDM; or 10 to 40 mole % of residues of TMCD and 60 to 90 mole % of residues of CHDM; or 10 to 35 mole % of residues of TMCD and 65 to 90 mole % of residues of CHDM; or 15 to 50 mole % of residues of TMCD and 50 to 85 mole % of residues of CHDM; or 15 to 45 mole % of residues of TMCD and 55 to 85 mole % of residues of CHDM; or 15 to 40 mole % of residues of TMCD and 60 to 85 mole % of residues of CHDM; or 15 to 35 mole % of residues of TMCD and 65 to 85 mole % of residues of CHDM; or 20 to 45 mole % of residues of TMCD and 55 to 80 mole % of residues of CHDM; or 20 to 40 mole % of residues of TMCD and 60 to 80 mole % of residues of CHDM; or 20 to 35 mole % of residues of TMCD and 65 to 80 mole % of residues of CHDM; or 25 to 45 mole % of residues of TMCD and 55 to 75 mole % of residues of CHDM; or 25 to 40 mole % of residues of TMCD and 60 to 75 mole % of residues of CHDM; or 25 to 35 mole % of residues of TMCD and 65 to 75 mole % of residues of CHDM; or 30 to 35 mole % of residues of TMCD and 65 to 70 mole % of residues of CHDM, based on the total mole percentages of glycol residues in the final polyester equaling 100 mole %.

In one aspect, the polyesters and/or polyester compositions of the invention, wherein the molar ratio of TMCD:CHDM is from 1:9 to 1:1, or from 1:4 to 1:1, or from or from 1:3 to 1:1.5, or from 1:3 to 1:1, or from 1-2 to 1:1, or from 1:1.5 to 1:1.

Optionally, the polyesters of the invention can comprise modifying glycols which can comprise the remaining mole percentages.

In one aspect, these modifying glycols can comprise diethylene glycol, 1,2-propanediol, 1,3-propanediol, 2-methyl-1,3-propanediol, ethylene glycol, 1,4-butanediol, 1,5-pentanediol, 1,6-hexanediol, p-xylene glycol, neopentyl glycol, isosorbide, polytetramethylene glycol, or mixtures thereof.

In one aspect, the polyesters and/or polyester compositions of the invention can comprise residues of ethylene glycol.

In one aspect, the polyesters and/or polyester compositions of the invention can comprise less than 55 mole %, or less than 50 mole %, or less than 40 mole %, or less than 35 mole %, or less than 30 mole %, or less than 25 mole %, or less than 20 mole %, or less than 15 mole %, or less than 10 mole %, or 0 mole % of ethylene glycol residues, based on the total mole percentages of glycol residues in the final polyester equaling 100 mole %.

In one aspect, the polyesters and/or polyester compositions of the invention can comprise residues of at least one of 1,3-propanediol, 1,4-butanediol, and neopentyl glycol, or mixtures of two or more.

In one aspect, the polyester compositions can comprise no hexanediol, and/or no propanediol, and/or no butanediol.

In one aspect, the polyesters and/or polyester compositions can comprise less than 10 mole %, or less than 5 mole %, or less than 2 mole %, or 0 mole % of trimethylolpropane.

In certain aspects of the invention, the polyester can contain less than about 2 mole %, or less than about 3 mole %, or less than about 4 mole %, or less than about 5 mole %, of a second modifying glycol having from 3 to 16 carbon atoms. In certain embodiments, the polyester contains only a second modifying glycol. It should be understood that some other glycol residues (such as diethylene glycol) may be formed in situ during processing.

In one aspect, the polyesters and/or polyester compositions can comprise less than 10 mole %, or less than 5 mole %, or less than 2 mole %, or 0 mole % of polyols.

In one aspect, the polyesters and/or polyester compositions can comprise less than 10 mole %, or less than 5 mole %, or less than 2 mole %, or 0 mole % of 1,4-bis(2-hydroxyethyl)terephthalate.

In one aspect, the polyesters and/or polyester compositions can comprise less than 10 mole %, or less than 5 mole %, or less than 2 mole %, or 0 mole % of tetramethylene glycol.

In certain aspects of the invention, the polyester can contain less than about 2 mole %, or less than about 3 mole %, or less than about 4 mole %, or less than about 5 mole %, of a second modifying glycol having from 3 to 16 carbon atoms. In certain embodiments, the polyester contains only a second modifying glycol. It should be understood that some other glycol residues (such as diethylene glycol) may be formed in situ during processing.

In one aspect, the diacid component of the polyesters of the invention can comprise modifying aromatic and/or aliphatic dicarboxylic acid ester residues.

In one aspect, the diacid component of the polyesters of the invention can comprise residues of dimethyl terephthalate.

In one aspect, the polyester compositions of the invention can comprise:
(1) at least one polyester which comprises:
   (a) a dicarboxylic acid component comprising:
      (i) about 70 to about 100 mole % residues of terephthalic acid or esters thereof;
      (ii) about 0 to about 30 mole % of aromatic and/or aliphatic dicarboxylic acid residues having up to 20 carbon atoms;
   (b) a glycol component comprising:
      (i) about 10 to about 50 mole % of 2,2,4,4-tetramethyl-1,3-cyclobutanediol residues;
      (ii) about 50 to about 80 mole % residues of 1,4-cyclohexanedimethanol;
wherein the total mole % of the dicarboxylic acid component of the final polyester is 100 mole % and
wherein the total mole % of the glycol component of the final polyester is 100 mole %; and
(2) residues comprising titanium atoms and zinc atoms, and less than 30 ppm, or less than 20 ppm, or less than 10 ppm, or less than 5 ppm, or less than 2 ppm, or from 0 to 30 ppm, or from 0 to 20 ppm, or from 0 to 10 ppm, or 0 ppm of tin atoms;
wherein the inherent viscosity is from 0.35 to 0.80 dL/g, or from 0.35 to 0.75 dL/g, or from 0.40 to 0.75, or from 0.45 to 0.75 dL/g, or from 0.50 to 0.75 dL/g, as determined in 60/40 (wt/wt) phenol/tetrachloroethane at a concentration of 0.5 g/100 ml at 25° C.; and having a b* value of less than 20, of less than 15, or less than 14, or less than 13, or less than 12, or less than 11, or less than 10, or less than 9, or less than 8.5, or less than 8, or less than 7, or less than 6, or less than 5, or from 1 to 10, or from 1 to 9, or from 1 to 8, or from 1 to 7, or from 1 to 6, or from 1 to 5, or from 2 to 6; and an L* value of from 70 to 95 or from 75 to 90, as determined by the L*a*b* color system of the CIE (International Commission on Illumination). In some embodiments, the a* value can also be less than 7, or less than 4, or less than 3, or less than 2, or less than 1, or less than 0, or less than −1, or less than −1.5, or less than −2.

In one aspect, for all of the polyesters and/or polyester compositions of the invention, the inherent viscosity can be from 0.35 to 1.2 dL/g, or from 0.35 to 0.80 dL/g, or from 0.35 to 0.75 dL/g, or from 0.35 to 0.70 dL/g, or from 0.35 to 0.60 dL/g, or from 0.40 to 0.75 dL/g, or from 0.40 to 0.70 dL/g, or from 0.40 to 0.65 dL/g, or from 0.40 to 0.60 dL/g, or from 0.45 to 0.75 dL/g, or from 0.45 to 0.70 dL/g, or from 0.45 to 0.65 dL/g, or from 0.45 to 0.60 dL/g, or from 0.50 to 1.2 dL/g, or from 0.50 to 0.80 dL/g, or from 0.50 to 0.75 dL/g, or from 0.50 to 0.70 dL/g, or from 0.50 to 0.65 dL/g, or from 0.50 to 0.60 dL/g, or from 0.55 to 0.75 dL/g, or from 0.55 to 0.70 dL/g, or from 0.60 to 0.75 dL/g, as determined in 60/40 (wt/wt) phenol/tetrachloroethane at a concentration of 0.5 g/100 ml at 25° C.

In one aspect, the polyesters and/or polyester compositions of the invention can have a Tg of from 85 to 130° C., or from 100 to 130° C., or from 100 to 125° C., or from 100 to 120° C., or from 85 to 120° C.

In one aspect, the polyesters and/or polyester compositions of the invention comprise at least one titanium source at least one of at least one of titanium carbonate, titanium acetate, titanium benzoate, titanium succinate, titanium isopropoxide, titanium methoxide, titanium oxalate, titanium nitrate, titanium ethoxide, titanium hydroxide, titanium hydride, titanium glycoxide, alkyl titanium, titanium zinc hydride, titanium borohydride, titanium oxide, titanium acetylacetonate oxide, titanium tri-isopropoxide chloride, titanium bis(acetylacetonate)di-isopropoxide, titanium n-butoxide, titanium tert-butoxide.

In one embodiment, the polyesters and/or polyester compositions of the invention comprise at least one titanium source selected from titanium dioxide, titanium isopropoxide, titanium acetylacetonate oxide, titanium bis(acetylacetonate)di-isopropoxide and/or combinations thereof.

In one aspect, the polyester compositions can comprise at least one zinc source which is catalytically active. These zinc compounds can include zinc compounds with at least one organic substituent.

Suitable examples of zinc compounds can comprise at least one the carboxylic acid salts of zinc. Examples of zinc can comprise at least one zinc source is selected from zinc borate, zinc oxide, zinc naphthenate, zinc tert-butoxide, zinc methoxide, zinc hydroxide, zinc acetate, zinc diacetate, zinc dihydrate, zinc octoate, zinc carbonate, dialkyl zinc, dimethyl zinc, diaryl zinc (e.g., diphenyl zinc), zinc isopropoxide, zinc phosphate, and/or zinc acetylacetonate.

In one aspect, the polyesters and/or polyester compositions of the invention can contain zinc acetylacetonate, and zinc isopropoxide. In one aspect, zinc acetate and/or zinc acetate dihydrate and/or zinc naphthenate, and/or zinc carbonate, and/or residues thereof or combinations thereof are not present.

In one aspect, the polyesters and/or polyester compositions of the invention can comprise zinc acetylacetonate.

In one aspect, the polyesters and/or polyester compositions of the invention can comprise titanium atoms in the amount of from 20 to 750 ppm, or from 20 to 500 ppm, or from 20 to 450 ppm, or from 20 to 400 ppm, or from 20 to 350 ppm, or from 20 to 300 ppm, or from 20 to 275 ppm, or from 20 to 250 ppm, or from 20 to 200 ppm, or from 50 to 1000 ppm, or from 50 to 750 ppm, or from 50 to 500 ppm, or from 50 to 450 ppm, or from 50 to 400 ppm, or from 50 to 300 ppm, or from 50 to 275 ppm, or from 50 to 250 ppm, or from 50 to 200 ppm, or from 60 to 1000 ppm, or from 60 to 750 ppm, or from 60 to 500 ppm, or from 60 to 450 ppm, or from 60 to 400 ppm, or from 60 to 350 ppm, or from 60 to 300 ppm, or from 60 to 275 ppm, or from 60 to 250 ppm, or from 60 to 200 ppm, or from 60 to 150 ppm, or from 60 to 100 ppm, or from 75 to 1000 ppm, or from 75 to 750 ppm, or from 75 to 500 ppm, or from 75 to 450 ppm, or from 75 to 400 ppm, or from 75 to 350 ppm, or from 75 to 300 ppm, or from 75 to 250 ppm, or from 75 to 200 ppm, or from 70 to 100 ppm, or from 70 to 90 ppm, or from 65 to 100 ppm, or from 65 to 90 ppm or from 80 to 1000 ppm, or from 80 to 750 ppm, or from 80 to 500 ppm, or from 80 to 450 ppm, or from 80 to 400 ppm, or from 80 to 350 ppm, or from 80 to 300 ppm, or from 80 to 275 ppm, or from 80 to 250 ppm, or from 80 to 200 ppm, or from 100 to 1000 ppm, or from 100 to 750 ppm, or from 100 to 500 ppm, or from 100 to 450 ppm, or from 100 to 400 ppm, or from 100 to 350 ppm, or from 100 to 300 ppm, or from 100 to 275 ppm, or from 100 to 250 ppm, or from 100 to 200, or from 150 to 1000 ppm, or from 150 to 750 ppm, or from 150 to 500 ppm, or from 150 to 450 ppm, or from 150 to 400 ppm, or from 150 to 350 ppm, or from 150 to 300 ppm, or from 150 to 250 ppm, or from 200 to 1000 ppm, or from 200 to 750 ppm, or from 200 to 500 ppm, or from 200 to 450 ppm, or from 200 to 400 ppm, or from 200 to 350 ppm, or from 200 to 300 ppm, or from 200 to 250 ppm, relative to the mass of final polyester being prepared.

In one aspect, the polyesters and/or polyester compositions of the invention can comprise zinc atoms in the amount of from 50 to 1000 ppm, or from 50 to 750 ppm, or from 50 to 500 ppm, or from 50 to 450 ppm, or from 50 to 400 ppm, or from 50 to 300 ppm, or from 50 to 275 ppm, or from 50 to 250 ppm, or from 50 to 200 ppm, or from 60 to 1000 ppm, or from 60 to 750 ppm, or from 60 to 500 ppm, or from 60 to 450 ppm, or from 60 to 400 ppm, or from 60 to 350 ppm, or from 60 to 300 ppm, or from 60 to 275 ppm, or from 60 to 250 ppm, or from 60 to 200 ppm, or from 60 to 150 ppm, or from 60 to 100 ppm, or from 75 to 1000 ppm, or from 75 to 750 ppm, or from 75 to 500 ppm, or from 75 to 450 ppm, or from 75 to 400 ppm, or from 75 to 350 ppm, or from 75 to 300 ppm, or from 75 to 250 ppm, or from 75 to 200 ppm, or from 70 to 100 ppm, or from 70 to 90 ppm, or from 65 to 100 ppm, or from 65 to 90 ppm or from 80 to 1000 ppm, or from 80 to 750 ppm, or from 80 to 500 ppm, or from 80 to 450 ppm, or from 80 to 400 ppm, or from 80 to 350 ppm, or from 80 to 300 ppm, or from 80 to 275 ppm, or from 80 to 250 ppm, or from 80 to 200 ppm, or from 100 to 1000 ppm, or from 100 to 750 ppm, or from 100 to 500 ppm, or from 100 to 450 ppm, or from 100 to 400 ppm, or from 100 to 350 ppm, or from 100 to 300 ppm, or from 100 to 275 ppm, or from 100 to 250 ppm, or from 100 to 200, or from 150 to 1000 ppm, or from 150 to 750 ppm, or from 150 to 500 ppm, or from 150 to 450 ppm, or from 150 to 400 ppm, or from 150 to 350 ppm, or from 150 to 300 ppm, or from 150 to 250 ppm, or from 200 to 1000 ppm, or from 200 to 750 ppm, or from 200 to 500 ppm, or from 200 to 450 ppm, or from 200 to 400 ppm, or from 200 to 350 ppm, or from 200 to 300 ppm, or from 200 to 250 ppm, relative to the mass of final polyester being prepared.

In one aspect, polyesters and/or polyester compositions of the invention are provided wherein the ratio of titanium atoms to zinc atoms in ppm relative to the mass of final polyester being prepared can be from 0.50-1:5 to 5:1, or from 0.50-1:4 to 4:1, or from 0.50-1:3 to 3:1, or from 0.50:1 to 1:5, or from 0.50-1 to 1:4, or from 0.60-1:5 to 5:1, or from 0.60-1:4 to 4:1, or from 0.60-1:3 to 3:1, or from 0.60:1 to 1:5, or from 0.60-1 to 1:4, or from 0.70-1:5 to 5:1, or from 0.70-1:4 to 4:1, or from 0.70-1:3 to 3:1, or from 0.70-1:2 to 2:1, or from 0.70-1.2 to 1:4, or from 0.75-1:5 to 5:1, or from 0.75-1.2 to 1:4 to 4:1, or from 0.75-1:3 to 3:1, or from 0.75-1:2 to 2:1, or from 0.75-1.0 to 1:4, or from 0.80:1.2 to 1:4, or from 1.0 to 1.5:1.0 to 1:7.1, or from 1.0 to 1.5:1.0 to 3, or from 1.0 to 1.5:1.0 to 2, or from 1.0 to 1.5:1.0 to 2.5, or from 0.80-1:5 to 5:1, or from 0.80-1:5 to 5:1, or from 0.80-1.2 to 1:4 to 4:1, or from 0.80-1:3 to 3:1, or from 0.80-1:2 to 2:1, or from 0.80-1.2 to 1:4.

In one aspect, the polyesters and/or polyester compositions of the invention can have a total of catalyst metal atoms present in the composition in the range of from 150 to 800 ppm, or from 150 to 725 ppm, or from 150 to 700 ppm, or from 150 to 500 ppm, or from 150 to 450 ppm, or from 150 to 400 ppm, or from 150 to 300 ppm, 200 to 800 ppm, or from 200 to 725 ppm, or from 200 to 700 ppm, or from 200 to 600 ppm, or from 200 to 500 ppm, or from 200 to 450 ppm, or from 200 to 400 ppm, or from 200 to 300 ppm, or from 250 to 800 ppm, or from 250 to 725 ppm, or from 250 to 700 ppm, or from 250 to 500 ppm, or from 250 to 450 ppm, or from 250 to 400 ppm, or from 300 to 800 ppm, or from 300 to 725 ppm, or from 300 to 700 ppm, or from 300 to 500 ppm, or from 300 to 450 ppm, or from 300 to 400 ppm, or from 350 to 800 ppm, or from 350 to 725 ppm, or from 350 to 700 ppm, or from 350 to 500 ppm, or from 350 to 450 ppm, relative to the mass of final polyester being prepared.

In one aspect, the polyesters and/or polyester compositions of the invention can include polyesters having a degree of polymerization of from 0.01 to 300, or 0.01 to 250, or 0.01 to 200, or 0.01 to 150, or 0.01 to 130, or 0.01 to 120, or 0.10 to 300, or 0.10 to 250, or 0.10 to 200, or 0.10 to 150, or 0.10 to 130, or 0.10 to 120, or 0.20 to 300, or 0.20 to 250, or 0.20 to 200, or 0.20 to 150, or 0.20 to 130, or 0.20 to 120, or 0.15 to 300, or 0.15 to 250, or 0.15 to 200, or 0.15 to 150, or 0.15 to 130, or 0.15 to 120.

In one aspect, the polyesters and/or polyester compositions of the invention can have a number average molecular weight of from 4,800 to 16,000.

In one aspect, the polyesters and/or polyester compositions of the invention can have a b* value of from −10 to less than 20; or from −10 to less than 18; or from −10 to less than 15; or from −10 to less than 14; or from −10 to less than 10; or from 1 to less than 20; or from 1 to less than 18; or from 5 to less than 20; or from 5 to less than 18; or from 8 to less than 20; or from 8 to less than 18; or from 8 to less than 15; or from −3 to 10; or from −5 to 5; or from −5 to 4; or from −5 to 3; or from 1 to 20; or from 1 to 18; or from 1 to 15; or from 1 to 14; or 1 to less than 10; or from 1 to 10; or from 1 to 9; or from 1 to 8; from 1 to 7; or from 1 to 6; or from 1 to 5; or from 2 to 25; or from 2 to 20; or from 2 to 18; or from 2 to 15; or from 2 to 14; or from 2 to less than 10; or from 2 to 9; or from 2 to 8; or from 2 to 7; or from 2 to 6; or from 2 to 5; or from 3 to 20; or from 3 to 18; or from 3 to 15; or from 3 to 14; or from 3 to less than 10; or from 3 to 8; or from 3 to less than 20; or less than 15; or less than 14; or less than 13; or less than 12; or less than 11; or less than 10; or less than 9; or less than 8.5; or less than 8; or less than 7; or less than 6; or less than 5; or less than 4; or less than 3; as determined by the L*a*b* color system of the CIE (International Commission on Illumination).

In one aspect, the polyesters and/or polyester compositions of the invention can have an L* value of from 50 to 99, or from 50 to 90, or from 60 to 99, or from 60 to 90, or from 60 to 85, or from 60 to 80, or from 60 to 75, or from 60 to 70, or from 65 to 99, or from 65 to 90, or from 65 to 85, or from 65 to 80, or from 65 to 75, or from 70 to 90, or from 70 to 99, or from 70 to 90, or from 70 to 85, or from 70 to 80, or from 75 to 95, or from 77 to 90, or from 75 to 90, or from 75 to 85, or from 80 to 95, or from 80 to 90, as determined by the L*a*b* color system of the CIE (International Commission on Illumination).

In one aspect, the b* and/or L* and/or a*values can be obtained in the presence of and/or in the absence of toner(s).

In one aspect, the polyesters and/or polyester compositions of the invention can comprise residues of at least one branching agent an amount of 0.01 to 10 mole %, or 0.01 to 5 mole %, based on the total mole percentage of the diacid or diol residues.

In one aspect, the polyesters and/or polyester compositions of the invention can have a melt viscosity less than 30,000, or less than 20,000, or less than 12,000, or less than 10,000, or less than 7,000, or less than 5,000 poise, or less than 3,000 poise, as measured at 1 radian/second on a rotary melt rheometer at 290° C.

In one aspect, the polyesters and/or polyester compositions of the invention can have a notched Izod impact strength of at least 1 ft-lbs/inch, or at least 2 ft-lbs/inch, or at least 3 ft-lbs/inch, or 7.5 ft-lbs/in, or 10 ft-lbs/in at 23° C. according to ASTM D256 with a 10-mil notch in a ⅛-inch thick bar.

In one aspect, the polyester composition can comprise methyl groups in the amount of 5.0 mole % or less, or 4.5 mole % or less, or 4 mole % or less, or 3.5 mole % or less, or 3 mole % or less, or 2.5 mole % of less, or 2.0 mole % or less, or 1.5 mole % or less, or 1.0 mole % or less in the final polyesters and/or polyester compositions of the invention.

In one aspect, the polyesters and/or polyester compositions of the invention can comprise 2,2,4,4-tetramethyl-1,3-cyclobutanediol residues which are a mixture comprising greater than 50 mole % of cis-2,2,4,4-tetramethyl-1,3-cyclobutanediol and less than 50 mole % of trans-2,2,4,4-tetramethyl-1,3-cyclobutanediol, or greater than 70 mole % of cis-2,2,4,4-tetramethyl-1,3-cyclobutanediol and less than 30 mole % of trans-2,2,4,4-tetramethyl-1,3-cyclobutanediol, or greater than 75 mole % of cis-TMCD and less than 25 mole % of trans-TMCD; or greater than 80 mole % of cis-TMCD and less than 20 mole % of trans-TMCD; or greater than 85 mole % of cis-TMCD and less than 15 mole % of trans-TMCD; or greater than 90 mole % of cis-2,2,4,4-tetramethyl-1,3-cyclobutanediol and less than 10 mole % of trans-2,2,4,4-tetramethyl-1,3-cyclobutanediol, or greater than 95 mole % of cis-2,2,4,4-tetramethyl-1,3-cyclobutanediol and less than 5 mole % of trans-2,2,4,4-tetramethyl-1,3-cyclobutanediol.

In one aspect, the polyester compositions of the invention can comprise blends of at least one polyester useful in the invention and at least one polymer chosen from at least one of the following: other polyesters (such as polyethylene terephthalate (PET) (including recycled PET, i.e., rPET), poly(cyclohexylene) terephthalate (e.g., PCT), modified PET or PET modified with 1,4-cyclohexanedimethanol CHDM (e.g., PETG), poly(etherimides), polyphenylene oxides, poly(phenylene oxide)/polystyrene blends, polystyrene resins, polyphenylene sulfides, polyphenylene sulfide/sulfones, poly(ester-carbonates), polycarbonates, polysulfones; polysulfone ethers, and poly(ether-ketones).

In one aspect, the polyester compositions of the invention can comprise at least one polycarbonate, or no polycarbonate, or no carbonate groups.

In one aspect, the polyesters and/or polyester compositions of the invention can contain no crosslinking agent.

In one aspect, the polyester compositions of the invention can comprise residues of at least one phosphorus compound.

In one aspect, the polyester compositions of the invention can comprise residues of phosphoric acid, phosphorous acid, phosphonic acid, phosphinic acid, phosphonous acid, and/or various esters and/or salts thereof. These esters can be alkyl, branched alkyl, substituted alkyl, difunctional alkyl, alkyl ethers, aryl, and substituted aryl.

In one aspect, the polyester compositions of the invention can comprise at least one of substituted or unsubstituted alkyl phosphate esters, substituted or unsubstituted aryl phosphate esters, substituted or unsubstituted mixed alkyl aryl phosphate esters, diphosphites, salts of phosphoric acid, phosphine oxides, and mixed aryl alkyl phosphites, reaction products thereof, and/or mixtures thereof.

In one aspect, the polyester compositions of the invention can comprise at least one of substituted or unsubstituted alkyl phosphate esters, substituted or unsubstituted aryl phosphate esters, mixed substituted or unsubstituted alkyl aryl phosphate esters, reaction products thereof, and mixtures thereof.

In one aspect, the polyester compositions of the invention can comprise no phosphorus compound.

In one aspect, the polyesters and/or polyester compositions of the invention can comprise less than 30 ppm, or less than 20 ppm, or less than 10 ppm, or less than 5 ppm, or less than 2 ppm, or from 0 to 30 ppm, or from 0 to 20 ppm, or from 0 to 10 ppm, or 0 ppm tin atoms.

In one aspect, the polyesters and/or polyester compositions of the invention can comprise less than 30 ppm, or less than 20 ppm, or less than 10 ppm, or less than 5 ppm, or less than 2 ppm, or from 0 to 30 ppm, or from 0 to 20 ppm, or from 0 to 10 ppm, or 0 ppm manganese atoms.

In one aspect, the polyesters and/or polyester compositions of the invention can comprise less than 30 ppm, or less than 20 ppm, or less than 10 ppm, or less than 5 ppm, or less than 2 ppm, or from 0 to 30 ppm, or from 0 to 20 ppm, or from 0 to 10 ppm, or 0 ppm cobalt atoms.

In one aspect, the polyesters and/or polyester compositions of the invention can comprise less than 30 ppm, or less than 20 ppm, or less than 10 ppm, or less than 5 ppm, or less than 2 ppm, or from 0 to 30 ppm, or from 0 to 20 ppm, or from 0 to 10 ppm, or 0 ppm of any of tin atoms and germanium atoms.

In one aspect, the polyesters and/or polyester compositions of the invention can comprise less than 30 ppm, or less than 20 ppm, or less than 10 ppm, or less than 5 ppm, or less than 2 ppm, or from 0 to 30 ppm, or from 0 to 20 ppm, or from 0 to 10 ppm, or 0 ppm of any of antimony atoms and/or germanium atoms.

In one aspect, the polyesters and/or polyester compositions of the invention can comprise less than 30 ppm, or less than 20 ppm, or less than 10 ppm, or less than 5 ppm, or less than 2 ppm, or from 0 to 30 ppm, or from 0 to 20 ppm, or from 0 to 10 ppm, or 0 ppm of any of tin atoms and manganese atoms.

In one aspect, the polyesters and/or polyester compositions of the invention can comprise less than 30 ppm, or less than 20 ppm, or less than 10 ppm, or less than 5 ppm, or less than 2 ppm, or from 0 to 30 ppm, or from 0 to 20 ppm, or from 0 to 10 ppm, or 0 ppm of any of tin atoms and/or aluminum atoms

In one aspect, the polyesters and/or polyester compositions of the invention can comprise less than 30 ppm, or less than 20 ppm, or less than 10 ppm, or less than 5 ppm, or less than 2 ppm, or from 0 to 30 ppm, or from 0 to 20 ppm, or from 0 to 10 ppm, or 0 ppm of any of lithium and/or aluminum atoms.

In one aspect, the polyesters and/or polyester compositions of the invention can comprise less than 30 ppm, or less than 20 ppm, or less than 10 ppm, or less than 5 ppm, or less than 2 ppm, or from 0 to 30 ppm, or from 0 to 20 ppm, or from 0 to 10 ppm, or 0 ppm of any of tin atoms, lithium, and/or aluminum atoms.

In one aspect, the polyesters and/or polyester compositions of the invention can comprise less than 30 ppm, or less than 20 ppm, or less than 10 ppm, or less than 5 ppm, or less than 2 ppm, or from 0 to 30 ppm, or from 0 to 20 ppm, or from 0 to 10 ppm, or 0 ppm of any of the following: tin atoms, and/or manganese atoms, and/or magnesium atoms, and/or germanium atoms, and/or antimony atoms, cobalt atoms, and/or cadmium atoms, and/or calcium atoms, and/or sodium atoms, and/or gallium atoms, and can exclude any combination of these or can exclude all of these.

In one aspect, the polyesters and/or polyester compositions of the invention can comprise less than 30 ppm, or less than 20 ppm, or less than 10 ppm, or less than 5 ppm, or less than 2 ppm, or from 0 to 30 ppm, or from 0 to 20 ppm, or from 0 to 10 ppm, or 0 ppm of any of the following: tin atoms, manganese atoms, magnesium atoms, germanium atoms, antimony atoms, cobalt atoms, and/or calcium atoms, and can exclude any combination of these or can exclude all of these.

In one aspect, the polyesters and/or polyester compositions of the invention can comprise less than 30 ppm, or less than 20 ppm, or less than 10 ppm, or less than 5 ppm, or less than 2 ppm, or from 0 to 30 ppm, or from 0 to 20 ppm, or from 0 to 10 ppm, or 0 ppm of any of the following: tin atoms, manganese atoms, lithium atoms, germanium atoms, and cobalt atoms, and can exclude any combination of these or can exclude all of these.

In one aspect, the polyesters and/or polyester compositions of the invention can comprise less than 30 ppm, or less than 20 ppm, or less than 10 ppm, or less than 5 ppm, or less than 2 ppm, or from 0 to 30 ppm, or from 0 to 20 ppm, or from 0 to 10 ppm, or 0 ppm of gallium atoms.

In one aspect, the polyesters and/or polyester compositions of the invention can comprise less than 30 ppm, or less than 20 ppm, or less than 10 ppm, or less than 5 ppm, or less than 2 ppm, or from 0 to 30 ppm, or from 0 to 20 ppm, or from 0 to 10 ppm, or 0 ppm of any of sodium atoms and/or potassium atoms.

In one aspect, there is provided a process for making any of the polyester compositions herein comprising the following steps:
(I) heating a mixture at least one temperature chosen from 150° C. to 300° C., under at least one pressure chosen from the range of 0 psig to 100 psig wherein said mixture comprises:
   (a) a dicarboxylic acid component comprising:
      (i) 70 to 100 mole % of terephthalic acid residues;
      (ii) 0 to 30 mole % of aromatic dicarboxylic acid residues having up to 20 carbon atoms; and
      (iii) 0 to 10 mole % of aliphatic dicarboxylic acid residues having up to 16 carbon atoms; and
   (b) a glycol component comprising:
      (i) 10 to 50 mole % of 2,2,4,4-tetramethyl-1,3-cyclobutanediol residues; and
      (ii) 50 to 90 mole % of modifying 1,4-cyclohexanedimethanol residues;
wherein the molar ratio of glycol component/dicarboxylic acid component added in Step (I) is 1.0-1.5/1.0;
(II) heating the product of Step (I) at a temperature of 230° C. to 320° C. for 1 to 6 hours under at least one pressure chosen from the range of the final pressure of Step (I) to 0.02 torr absolute;
wherein the mixture in Steps (I) or (II), respectively, when heated, is heated in the presence of at least one catalyst selected from at least one zinc compound and one titanium compound; and
wherein the final product after Step (II) comprises titanium atoms and zinc atoms;
wherein the total mole % of the dicarboxylic acid component of the final polyester is 100 mole %;
wherein the total mole % of the glycol component of the final polyester is 100 mole %;
wherein the inherent viscosity of the final polyester is from 0.35 to 1.2 dL/g as determined in 60/40 (wt/wt) phenol/tetrachloroethane at a concentration of 0.25 g/50 ml at 25° C.; and
wherein the final polyester has a Tg from 85° C. to 200° C.

In one aspect, the process above is provided except that the titanium catalyst source is added in Step (I) and the source of said zinc catalyst is added in Step (II).

In one aspect, the processes of making the polyesters useful in the invention can comprise a batch or continuous process.

In one aspect, the processes of making the polyesters useful in the invention comprise a continuous process.

In one aspect, the invention relates to a process for making a polyester comprising the following steps:
(I) heating a mixture at least one temperature chosen from 150° C. to 300° C., under at least one pressure chosen from the range of 0 psig to 100 psig wherein said mixture comprises:
   (a) a dicarboxylic acid component comprising:
      (i) about 90 to about 100 mole % of terephthalic acid residues;
      (ii) about 0 to about 10 mole % of aromatic and/or aliphatic dicarboxylic acid residues having up to 20 carbon atoms; and
   (b) a glycol component comprising:
      (i) about 10 to about 50 mole % 2,2,4,4-tetramethyl-1,3-cyclobutanediol residues; and
      (ii) about 50 to about 90 mole % of residues of 1,4-cyclohexanedimethanol;
wherein the molar ratio of glycol component/dicarboxylic acid component added in Step (I) is 1.01-3.0/1.0 and wherein TMCD is added in an amount from about 10 to 50 mole %, optionally, to allow for at least 30% conversion of TMCD in the reaction, and to arrive at a final polymer having about 10 to 50 mole % 2,2,4,4-tetramethyl-1,3-cyclobutanediol residues and about 50 to about 90 mole % 1,4-cyclohexanedimethanol residues;
wherein the mixture in Step (I) is heated in the presence of:
   (i) at least two catalysts comprising Li and Al; and (ii) and, optionally, at least one phosphorus compound;
(II) heating the product of Step (I) at a temperature of 230° C. to 320° C. for 1 to 6 hours, under at least one pressure chosen from the range of the final pressure of Step (I) to 0.02 torr absolute, to form a final polyester;
wherein the total mole % of the dicarboxylic acid component of the final polyester is 100 mole % and
wherein the total mole % of the glycol component of the final polyester is 100 mole %; and
wherein the inherent viscosity of the polyester is from 0.35 to 0.80 dL/g as determined in 60/40 (wt/wt) phenol/tetrachloroethane at a concentration of 0.25 g/50 ml at 25° C.; and wherein the L* color values for the polyester is 75 or greater, or greater than 75, as determined by the L*a*b* color system measured following ASTM D 6290-98 and ASTM E308-99, performed on polymer granules ground to pass a 1 mm sieve. In certain aspects, the catalyst comprises no tin. In one aspect, the polyesters useful in the invention can comprise at least one phosphate ester whether or not present as a thermal stabilizer.

In one aspect, the polyesters useful in the invention contain no branching agent, or alternatively, at least one branching agent is added either prior to or during polymerization of the polyester.

In one aspect, the polyesters useful in the invention contain at least one branching agent without regard to the method or sequence in which it is added.

In one aspect, certain polyesters useful in the invention may be amorphous or semicrystalline. In one aspect, certain polyesters useful in the invention can have a relatively low crystallinity. Certain polyesters useful in the invention can thus have a substantially amorphous morphology, meaning that the polyesters comprise substantially unordered regions of polymer.

At least one phosphorus compound useful in the invention are chosen from at least one of alkyl phosphate esters, aryl phosphate esters, mixed alkyl aryl phosphate esters, reaction products, thereof, and mixtures thereof.

In one aspect, at least one phosphorus compound useful in the invention may comprise at least one aryl phosphate ester.

In one aspect, at least one phosphorus compound useful in the invention may comprise at least one unsubstituted aryl phosphate ester.

In one aspect, at least one phosphorus compound useful in the invention may comprise at least one aryl phosphate ester which is not substituted with benzyl groups.

In one aspect, at least one phosphorus compound useful in the invention may comprise at least one triaryl phosphate ester.

In one aspect, at least one phosphorus compound useful in the invention may comprise at least one triaryl phosphate ester which is not substituted with benzyl groups.

In one aspect, at least one phosphorus compound useful in the invention may comprise at least one alkyl phosphate ester.

In one aspect, at least one phosphorus compound useful in the invention may comprise triphenyl phosphate and/or Merpol A. In one aspect, any of the polyester compositions of the invention may comprise triphenyl phosphate.

In one aspect, any of the processes described herein for making any of the polyester compositions and/or polyesters can comprise at least one mixed alkyl aryl phosphite, such as, for example, bis(2,4-dicumylphenyl)pentaerythritol diphosphite also known as Doverphos S-9228 (Dover Chemicals, CAS #154862-43-8).

In one aspect, any of the processes described herein for making any of the polyester compositions and/or polyesters can comprise at least one one phosphine oxide.

In one aspect, any of the processes described herein for making any of the polyester compositions and/or polyesters can comprise at least one salt of phosphoric acid such as, for example, KH2PO4 and Zn3(PO4)2.

It is believed that any of the processes of making the polyesters useful in the invention may be used to make any of the polyesters useful in the invention.

In one aspect, the pressure used in Step (I) of any of the processes of the invention consists of at least one pressure chosen from 0 psig to 75 psig. In one aspect, the pressure used in Step (I) of any of the processes of the invention consists of at least one pressure chosen from 0 psig to 50 psig.

In one aspect, the pressure used in Step (II) of any of the processes of the invention consists of at least one pressure chosen from 20 torr absolute to 0.02 torr absolute; in one aspect, the pressure used in Step (II) of any of the processes of the invention consists of at least one pressure chosen from 10 torr absolute to 0.02 torr absolute; in one aspect, the pressure used in Step (II) of any of the processes of the invention consists of at least one pressure chosen from 5 torr absolute to 0.02 torr absolute; in one aspect, the pressure used in Step (II) of any of the processes of the invention consists of at least one pressure chosen from 3 torr absolute to 0.02 torr absolute; in one aspect, the pressure used in Step (II) of any of the processes of the invention consists of at least one pressure chosen from 20 torr absolute to 0.1 torr absolute; in one aspect, the pressure used in Step (II) of any of the processes of the invention consists of at least one pressure chosen from 10 torr absolute to 0.1 torr absolute; in one aspect, the pressure used in Step (II) of any of the processes of the invention consists of at least one pressure chosen from 5 torr absolute to 0.1 torr absolute; in one aspect, the pressure used in Step (II) of any of the processes of the invention consists of at least one pressure chosen from 3 torr absolute to 0.1 torr absolute.

In one aspect, the molar ratio of glycol component/dicarboxylic acid component added in Step (I) of any of the processes of the invention is 1.0-3.0/1.0; in one aspect, the molar ratio of glycol component/dicarboxylic acid component added in Step (I) of any of the processes of the invention is 1.0-2.5/1.0; in one aspect, the molar ratio of glycol component/dicarboxylic acid component added in Step (I) of any of the processes of the invention is 1.0-2.0/1.0; in one aspect, the molar ratio of glycol component/dicarboxylic acid component added in Step (I) of any of the processes of the invention is 1.0-1.75/1.0; in one aspect, the molar ratio of glycol component/dicarboxylic acid component added in Step (I) of any of the processes of the invention is 1.0-1.5/1.0.

In one aspect, the molar ratio of glycol component/dicarboxylic acid component added in Step (I) of any of the processes of the invention is 1.01-3.0/1.0; in one aspect, the molar ratio of glycol component/dicarboxylic acid component added in Step (I) of any of the processes of the invention is 1.01-2.5/1.0; in one aspect, the molar ratio of glycol component/dicarboxylic acid component added in Step (I) of any of the processes of the invention is 1.01-2.0/1.0; in one aspect, the molar ratio of glycol component/dicarboxylic acid component added in Step (I) of any of the processes of the invention is 1.01-1.75/1.0; in one aspect, the molar ratio of glycol component/dicarboxylic acid component added in Step (I) of any of the processes of the invention is 1.01-1.5/1.0.

In any of the process embodiments for making the polyesters useful in the invention, the heating time of Step (II) may be from 1 to 5 hours. In any of the process embodiments for making the polyesters useful in the invention, the heating time of Step (II) may be from 1 to 4 hours. In any of the process embodiments for making the polyesters useful in the invention, the heating time of Step (II) may be from 1 to 3 hours. In any of the process embodiments for making the polyesters useful in the invention, the heating time of Step (II) may be from 1.5 to 3 hours. In any of the process embodiments for making the polyesters useful in the invention, the heating time of Step (II) may be from 1 to 2 hours.

The weight (ppm) of zinc atoms and titanium atoms present in the final polyester can be measured in the final polyester of any of the aforesaid weight ratios, for example.

In one aspect, the polyesters and/or polyester compositions of the invention can be useful for non-coating compositions, non-adhesive compositions, thermoplastic polyester compositions, articles of manufacture, shaped articles, thermoplastic shaped articles, molded articles, extruded articles, injection molded articles, blow molded articles, film and/or sheet (for example, calendered, cast, or extruded), thermoformed film or sheet, containers, and/or bottles (for example, baby bottles or sports bottles or water bottles).

In one aspect, the polyester compositions are useful in shaped articles, including, but not limited to, extruded, and/or molded articles including, but not limited to, injection molded articles, extruded articles, cast extrusion articles, profile extrusion articles, melt spun articles, thermoformed articles, extrusion molded articles, injection blow molded articles, injection stretch blow molded articles, extrusion blow molded articles and extrusion stretch blow molded articles. These articles can include, but are not limited to, films, bottles, containers, drinkware, medical parts, sheet and/or fibers.

In one aspect, the polyester compositions useful in the invention may be used in various types of film and/or sheet, including but not limited to extruded film(s) and/or sheet(s), compression molded film(s) and/or sheet(s), solution casted film(s) and/or sheet(s). Methods of making film and/or sheet include but are not limited to extrusion, compression molding, and solution casting.

In one aspect, the invention is related to thermoformed film(s) and/or sheet(s) comprising the polyester(s) and/or polyester compositions of the invention.

In one aspect, the invention is related to articles of manufacture which incorporate the thermoformed film and/or sheet of the invention.

In one aspect, any of the processes of making the polyesters useful in the invention and described herein or known by one of ordinary skill in the art may be used to make any of the polyesters and/or polyester composition of the invention.

In one aspect, any of the polyesters and/or polyester compositions described herein are also considered within the scope of this invention, regardless of which process is used to make them, and any products made therefrom.

In one aspect, the invention is related to articles of manufacture, e.g., shaped articles, that comprise any of the polyesters and/or polyester compositions of the invention.

### DETAILED DESCRIPTION OF THE INVENTION

The present invention may be understood more readily by reference to the following detailed description of certain embodiments of the invention and the working examples. In accordance with the purpose(s) of this invention, certain embodiments of the invention are described in the Summary of the Invention and are further described herein below. Also, other embodiments of the invention are described herein.

It is believed that certain polyesters and/or polyester composition(s) of the invention formed from terephthalic acid, an ester thereof, and/or mixtures thereof, 2,2,4,4-tetramethyl-1,3-cyclobutanediol and at least one modifying glycol, and, further comprising certain titanium and zinc catalysts and, optionally, stabilizers, reaction products thereof, and mixtures thereof, can have a unique combination of one or more, two or more, or three or more, of the following properties; good notched Izod impact strength, good inherent viscosities, good glass transition temperature (Tg), good flexural modulus, good tensile strength, good clarity, good color, good dishwasherability, good TMCD incorporation and good/improved melt stability.

In one aspect, copolyesters containing 2,2,4,4-tetramethyl-1,3-cyclobutanediol, 1,4-cyclohexanedimethanol, and, optionally, at least one modifying glycol over a range of compositions can be prepared with at least one titanium catalyst and at least one zinc catalyst.

The present invention relates to polyesters based on terephthalic acid or esters thereof, 2,2,4,4-tetramethyl-1,3-cyclobutanediol, 1,4-cyclohexanedimethanol, and, optionally, at least one modifying glycol, catalyzed by certain catalyst types and/or amounts that provide improved properties (as discussed herein), and in certain embodiments, at least one titanium catalyst and at least one zinc catalyst, resulting in good TMCD incorporation, improved color (higher brightness and/or less yellow), and reactivity to achieve desired inherent viscosity (IV) over the compositional range described herein.

When titanium is added to the polyesters and/or polyester compositions and/or process of making the polyesters of the invention, it is added to the process of making the polyester in the form of a titanium compound. The amount of the titanium compound added to the polyesters of the invention and/or polyester compositions of the invention and/or processes of the invention can be measured in the form of titanium atoms present in the final polyester, for example, by weight measured in ppm.

When zinc is added to the polyesters and/or polyester compositions and/or process of making the polyesters of the invention, it is added to the process of making the polyester in the form of a zinc compound. The amount of the zinc compound added to the polyesters of the invention and/or polyester compositions of the invention and/or processes of the invention can be measured in the form of zinc atoms present in the final polyester, for example, by weight measured in ppm.

When phosphorus is added to the polyesters and/or polyester compositions and/or process of making the polyesters of the invention, it is added to the process of making the polyester in the form of a phosphorus compound. In one aspect, this phosphorus compound can comprise at least one phosphate ester(s). The amount of phosphorus compound, [for example, phosphate ester(s)] added to the polyesters of the invention and/or polyester compositions of the invention and/or processes of the invention can be measured in the form of phosphorus atoms present in the final polyester, for example, by weight measured in ppm.

The term “polyester”, as used herein, is intended to include “copolyesters” and is understood to mean a synthetic polymer prepared by the reaction of one or more difunctional carboxylic acids and/or multifunctional carboxylic acids with one or more difunctional hydroxyl compounds and/or multifunctional hydroxyl compounds, for example, branching agents. Typically, the difunctional carboxylic acid can be a dicarboxylic acid and the difunctional hydroxyl compound can be a dihydric alcohol such as, for example, glycols and diols. The term “glycol” as used herein includes, but is not limited to, diols, glycols, and/or multifunctional hydroxyl compounds, for example, branching agents. Alternatively, the difunctional carboxylic acid may be a hydroxy carboxylic acid such as, for example, p-hydroxybenzoic acid, and the difunctional hydroxyl compound may be an aromatic nucleus bearing 2 hydroxyl substituents such as, for example, hydroquinone. The term “residue”, as used herein, means any organic structure incorporated into a polymer through a polycondensation and/or an esterification reaction from the corresponding monomer. The term “repeating unit”, as used herein, means an organic structure having a dicarboxylic acid residue and a diol residue bonded through a carbonyloxy group. Thus, for example, the dicarboxylic acid residues may be derived from a dicarboxylic acid monomer or its associated acid halides, esters, salts, anhydrides, and/or mixtures thereof. Furthermore, as used herein, the term “diacid” includes multifunctional acids, for example, branching agents. As used herein, therefore, the term “dicarboxylic acid” is intended to include dicarboxylic acids and any derivative of a dicarboxylic acid, including its associated acid halides, esters, half-esters, salts, half-salts, anhydrides, mixed anhydrides, and/or mixtures thereof, useful in a reaction process with a diol to make polyester. As used herein, the term “terephthalic acid” is intended to include terephthalic acid itself and residues thereof as well as any derivative of terephthalic acid, including its associated acid halides, esters, half-esters, salts, half-salts, anhydrides, mixed anhydrides, and/or mixtures thereof or residues thereof useful in a reaction process with a diol to make polyester.

The polyesters used in the present invention typically can be prepared from dicarboxylic acids and diols which react in substantially equal proportions and are incorporated into the polyester polymer as their corresponding residues. The polyesters of the present invention, therefore, can contain substantially equal molar proportions of acid residues (100 mole %) and diol (and/or multifunctional hydroxyl compound) residues (100 mole %) such that the total moles of repeating units is equal to 100 mole %. The mole percentages provided in the present disclosure, therefore, may be based on the total moles of acid residues, the total moles of diol residues, or the total moles of repeating units. For example, a polyester containing 10 mole % isophthalic acid, based on the total acid residues, means the polyester contains 10 mole % isophthalic acid residues out of a total of 100 mole % acid residues. Thus, there are 10 moles of isophthalic acid residues among every 100 moles of acid residues. In another example, a polyester containing 25 mole % 2,2,4,4-tetramethyl-1,3-cyclobutanediol, based on the total diol residues, means the polyester contains 25 mole % 2,2,4,4-tetramethyl-1,3-cyclobutanediol residues out of a total of 100 mole % diol residues. Thus, there are 25 moles of 2,2,4,4-tetramethyl-1,3-cyclobutanediol residues among every 100 moles.

In one embodiment, a copolyester composition is provided comprising a copolyester, optionally, having good color, good TMCD incorporation, and/or reactivity to achieve the desired inherent viscosity over the entire compositional range that includes: (a) a dicarboxylic acid component comprising about 10 to about 50 mole % 2,2,4,4-tetramethyl-1,3-cyclobutanediol (TMCD) residues and about 50 to about 90 mole % 1,4-cyclohexanedimethanol (CHDM) residues; wherein the total mole % of the dicarboxylic acid component of the final polyester is 100 mole % and wherein the total mole % of the glycol component of the final polyester is 100 mole %.

In one embodiment, the polyesters and/or polyester compositions of the invention can comprise residues of 2,2,4,4-tetramethyl-1,3-cyclobutanediol in the amount of from about 10 to about 55 mole %, or from about 10 to about 50 mole %, or from about 10 to about 45 mole %, or from about 10 to about 40 mole %, or from about 15 to about 55 mole %, or from about 15 to about 50 mole, or from about 15 to about 45 mole %, or from about 15 to about 40 mole %, or from about 20 to about 55 mole %, or from about 20 to about 50 mole %, or from about 20 to about 45 mole %, or from about 20 to about 40 mole %, or from about 20 to about 35 mole %, or from about 20 to about 30 mole %, or from about 25 to about 55 mole %, or from about 25 to about 50 mole %, or from about 25 to about 45 mole %, or from about 25 to about 40 mole %, or from about 30 to about 55 mole %, or from about 30 to about 50 mole %, or from about 30 to about 45 mole %, or from about 30 to about 40 mole %, or from about 35 to about 55 mole %, or from about 35 to about 50 mole %, or from about 35 to about 45 mole %, or from about 35 to about 45 mole %.

In one embodiment, the polyesters and/or polyester compositions of the invention can comprise residues of 2,2,4,4-tetramethyl-1,3-cyclobutanediol in the amount of from about 20 to about 50 mole %, or from about 20 to about 40 mole %, or from about 25 to about 50 mole %, or from about 30 to about 50 mole %, or from about 30 to about 45 mole.

In one embodiment, the polyesters and/or polyester compositions of the invention can comprise 1,4-cyclohexanedimethanol residues in the amount of from about 45 to about 90 mole %, or from about 50 to about 90 mole %, or from about 55 to about 90 mole %, or from about 60 to about 90 mole %, or from about 45 to about 85 mole %, or from about 50 to about 85 mole, or from about 55 to about 85 mole %, or from about 60 to about 85 mole %, or from about 45 to about 80 mole %, or from about 50 to about 80 mole %, or from about 55 to about 80 mole %, or from about 60 to about 80 mole %, or from about 65 to about 80 mole %, or from about 70 to about 80 mole %, or from about 45 to about 75 mole %, or from about 50 to about 75 mole %, or from about 55 to about 75 mole %, or from about 60 to about 75 mole %, or from about 45 to about 70 mole %, or from about 50 to about 70 mole %, or from about 55 to about 70 mole %, or from about 60 to about 70 mole %, or from about 45 to about 65 mole %, or from about 50 to about 65 mole %, or from about 55 to about 65 mole %.

In one embodiment, the polyesters and/or polyester compositions of the invention can comprise 1,4-cyclohexanedimethanol residues in the amount of from about 50 to about 80 mole %, or from about 60 to about 80 mole %, or from about 50 to about 75 mole %, or from about 50 to about 70 mole %, or from about 55 to about 70 mole %.

In one embodiment, the polyesters and/or polyester compositions of the invention can comprise residues of 2,2,4,4-tetramethyl-1,3-cyclobutanediol in the amount of 20 to 45 mole % and residues of 1,4-cyclohexanedimethanol in the amount of 55 to 80 mole %, or residues of 2,2,4,4-tetramethyl-1,3-cyclobutanediol in the amount of 20 to 40 mole % and residues of 1,4-cyclohexanedimethanol in the amount of 60 to 80 mole %, or residues of 2,2,4,4-tetramethyl-1,3-cyclobutanediol fin the amount of 20 to 35 mole % and residues of 1,4-cyclohexanedimethanol in the amount of 65 to 80 mole %, or 25 to 45 mole % and residues of 1,4-cyclohexanedimethanol in the amount of 55 to 75 mole %, or residues of 2,2,4,4-tetramethyl-1,3-cyclobutanediol in the amount of 25 to 40 mole % and residues of 1,4-cyclohexanedimethanol in the amount of 60 to 75 mole %, or residues of 2,2,4,4-tetramethyl-1,3-cyclobutanediol fin the amount of 25 to 35 mole % and residues of 1,4-cyclohexanedimethanol in the amount of 65 to 75 mole %; or residues of 2,2,4,4-tetramethyl-1,3-cyclobutanediol in the amount of 30 to 35 mole % and residues of 1,4-cyclohexanedimethanol in the amount of 65 to 70 mole %.

In one embodiment, the polyesters and/or the polyester compositions of the invention, wherein the molar ratio of TMCD:CHDM is from 1:9 to 1:1, or from 1:4 to 1:1, or from or from 1:3 to 1:1.5, or from 1:3 to 1:1, or from 1:2 to 1:1, or from 1:1.5 to 1:1.

In one embodiment, the polyesters useful in the polyester compositions of the invention can optionally comprise modifying glycol residues.

In one embodiment, these modifying glycols can comprise at least one of diethylene glycol, 1,2-propanediol, 1,3-propanediol, 2-methyl-1,3-propanediol, 1,4-cyclohexanedimethanol, ethylene glycol, 1,4-butanediol, 1,5-pentanediol, 1,6-hexanediol, p-xylene glycol, neopentyl glycol, isosorbide, polytetramethylene glycol, or mixtures thereof.

In one embodiment, the polyesters and/or the polyester compositions of the invention can comprise residues of ethylene glycol or can comprise no residues of ethylene glycol.

In one embodiment, the polyesters and/or the polyester compositions of the invention can comprise less than 55 mole %, or less than 50 mole %, or less than 40 mole %, or less than 35 mole %, or less than 30 mole %, or less than 25 mole %, or less than 20 mole %, or less than 15 mole %, or less than 10 mole %, or 0 mole % of ethylene glycol residues.

In one embodiment, the the polyesters and/or the polyester compositions of the invention can comprise less than 20 mole %, or less than 15 mole %, or less than 10 mole %, or less than 5 mole %, or less than 2 mole %, or 0 mole % of 1,3-propanediol, 1,4-butanediol, and/or neopentyl glycol.

In one embodiment, the the polyesters and/or the polyester compositions of the invention can comprise less than 20 mole %, or less than 15 mole %, or less than 10 mole %, or less than 5 mole %, or less than 2 mole %, or 0 mole % of neopentyl glycol residues and/or 1,4-butanediol residues.

In one embodiment, the polyesters and/or polyester compositions can comprise less than 20 mole %, or less than 15 mole %, or less than 10 mole %, or less than 5 mole %, or less than 2 mole %, or 0 mole % of trimethylolpropane.

In one embodiment, the polyesters and/or polyester compositions can comprise less than 20 mole %, or less than 15 mole %, or less than 10 mole %, or less than 5 mole %, or less than 2 mole %, or 0 mole % of polyols.

In one embodiment, the polyesters and/or polyester compositions can comprise less than 20 mole %, or less than 15 mole %, or less than 10 mole %, or less than 5 mole %, or less than 2 mole %, or 0 mole % of 1,4-bis(2-hydroxyethyl)terephthalate.

In one embodiment, the polyesters and/or polyester compositions can comprise less than 20 mole %, or less than 15 mole %, or less than 10 mole %, or less than 5 mole %, or less than 2 mole %, or 0 mole % of tetramethylene glycol.

In one embodiment, the polyesters and/or polyester compositions of the invention can comprise residues of at least one of 1,3-propanediol, 1,4-butanediol, and neopentyl glycol or mixtures of two or more.

In one embodiment, the extent of TMCD incorporation or conversion in the final polymer can be greater than 50 mole % of cis-2,2,4,4-tetramethyl-1,3-cyclobutanediol and less than 50 mole % of trans-2,2,4,4-tetramethyl-1,3-cyclobutanediol, or greater than 70 mole % of cis-2,2,4,4-tetramethyl-1,3-cyclobutanediol and less than 30 mole % of trans-2,2,4,4-tetramethyl-1,3-cyclobutanediol, or greater than 75 mole % of cis-TMCD and less than 25 mole % of trans-TMCD; or greater than 80 mole % of cis-TMCD and less than 20 mole % of trans-TMCD; or greater than 85 mole % of cis-TMCD and less than 15 mole % of trans-TMCD; or greater than 90 mole % of cis-2,2,4,4-tetramethyl-1,3-cyclobutanediol and less than 10 mole % of trans-2,2,4,4-tetramethyl-1,3-cyclobutanediol, or greater than 95 mole % of cis-2,2,4,4-tetramethyl-1,3-cyclobutanediol and less than 5 mole % of trans-2,2,4,4-tetramethyl-1,3-cyclobutanediol.

In one aspect, the diacid component of the polyesters of the invention can comprise modifying aromatic and/or aliphatic dicarboxylic acid ester residues.

In one embodiment, terephthalic acid may be used as the starting material. In another embodiment, dimethyl terephthalate may be used as the starting material. In yet another embodiment, mixtures of terephthalic acid and dimethyl terephthalate may be used as the starting material and/or as an intermediate material.

In certain embodiments, terephthalic acid or an ester thereof, such as, for example, dimethyl terephthalate or a mixture of terephthalic acid residues and an ester thereof can make up a portion or all of the dicarboxylic acid component used to form the polyesters useful in the invention. In certain embodiments, terephthalic acid residues can make up a portion or all of the dicarboxylic acid component used to form the polyesters useful in the invention. In certain embodiments, higher amounts of terephthalic acid can be used in order to produce a higher impact strength polyester. For purposes of this disclosure, the terms “terephthalic acid” and “dimethyl terephthalate” are used interchangeably herein. In one embodiment, dimethyl terephthalate is part or all of the dicarboxylic acid component used to make the polyesters useful in the present invention. In certain embodiments, ranges of from 70 to 100 mole %; or 80 to 100 mole %; or 90 to 100 mole %; or 99 to 100 mole %; or 100 mole % terephthalic acid and/or dimethyl terephthalate and/or mixtures thereof may be used.

In addition to terephthalic acid, the dicarboxylic acid component of the polyesters of the invention can comprise less than 30 mole %, or less than 20 mole %, or less than 10 mole %, or less than 5 mole %, or from 0 to 30 mole %, or from 0 to 20 mole %, or from 0 to 10 mole %, or from 0 to 5 mole %, or from 0 to 1 mole %, or 0.01 to 10 mole %, or 0.1 to 10 mole %, or 1 or 10 mole %, or 5 to 10 mole %, or 0 mole % of one or more modifying aromatic dicarboxylic acids. Yet another embodiment contains 0 mole % modifying aromatic dicarboxylic acids. Thus, if present, it is contemplated that the amount of one or more modifying aromatic dicarboxylic acids can range from any of these preceding endpoint values including, for example, 0.01 to 10 mole %, from 0.01 to 5 mole % and from 0.01 to 1 mole %. In one embodiment, modifying aromatic dicarboxylic acids that may be used in the present invention include but are not limited to those having up to 20 carbon atoms, and which can be linear, para-oriented, or symmetrical. Examples of modifying aromatic dicarboxylic acids which may be used in this invention include, but are not limited to, isophthalic acid, 4,4′-biphenyldicarboxylic acid, 1,4-, 1,5-, 2,6-, 2,7-naphthalenedicarboxylic acid, and trans-4,4′-stilbenedicarboxylic acid, and esters thereof. In one embodiment, the modifying aromatic dicarboxylic acid is isophthalic acid.

The carboxylic acid component of the polyesters of the invention can be further modified with less than 30 mole %, or less than 20 mole %, or less than 10 mole %, or less than 5 mole %, or from 0 to 30 mole %, or from 0 to 20 mole %, or from 0 to 10 mole %, or from 0 to 5 mole %, or from 0 to 1 mole %, or 0.01 to 10 mole %, or 0.1 to 10 mole %, or 1 or 10 mole %, or 5 to 10 mole %, or 0 mole %, of one or more aliphatic dicarboxylic acids containing 2-16 carbon atoms, such as, for example, cyclohexanedicarboxylic, malonic, succinic, glutaric, adipic, pimelic, suberic, azelaic and dodecanedioic dicarboxylic acids. Yet another embodiment contains 0 mole % modifying aliphatic dicarboxylic acids. The total mole % of the dicarboxylic acid component is 100 mole %. In one embodiment, adipic acid and/or glutaric acid are provided in the modifying aliphatic dicarboxylic acid component of the invention.

Esters of terephthalic acid and the other modifying dicarboxylic acids or their corresponding esters and/or salts may be used instead of the dicarboxylic acids. Suitable examples of dicarboxylic acid esters include, but are not limited to, the dimethyl, diethyl, dipropyl, diisopropyl, dibutyl, and diphenyl esters. In one embodiment, the esters are chosen from at least one of the following: methyl, ethyl, propyl, isopropyl, and phenyl esters.

In one embodiment, the diacid component of the polyesters and/or the polyester compositions of the invention can comprise residues of dimethyl terephthalate. In one embodiment, the diacid component comprises from 0 to 30 mole %, or 0 to 20 mole %, or 0 to 10 mole % of aliphatic diacid residues, including but not limited to, 1,4-cyclohexanedicarboxylic acid (CHDA), based on the total mole percentages of diacid residues in the final polyester equaling 100 mole %.

In one embodiment, the polyesters and/or polyester compositions of the invention can comprise CHDA in an amount of less than 30 mole %, or less than 20 mole %, or less than 10 mole %, or less than 5 mole %, or from 0 to 30 mole %, or from 0 to 20 mole %, or from 0 to 10 mole %, or from 0 to 5 mole %, or from 0 to 1 mole %, or 0.01 to 10 mole %, or 0.1 to 10 mole %, or 1 or 10 mole %, or 5 to 10 mole %, or 0 mole %, based on the total mole percentages of diacid residues in the final polyester equaling 100 mole %.

In one embodiment, the polyesters and/or polyester compositions of the invention can comprise trans-CHDA in an amount of less than 30 mole %, or less than 20 mole %, or less than 10 mole %, or less than 5 mole %, or from 0 to 30 mole %, or from 0 to 20 mole %, or from 0 to 10 mole %, or from 0 to 5 mole %, or from 0 to 1 mole %, or 0.01 to 10 mole %, or 0.1 to 10 mole %, or 1 or 10 mole %, or 5 to 10 mole %, or 0 mole %, based on the total mole percentages of diacid residues in the final polyester equaling 100 mole %.

In one embodiment, the polyesters and/or the polyester compositions of the invention can have a number average molecular weight of from 4,800 to 16,000.

In one embodiment, the polyesters and/or the polyester compositions of the invention can comprise:
(1) at least one polyester which comprises:
   (a) a dicarboxylic acid component comprising:
      (i) about 70 to about 100 mole % residues of terephthalic acid or esters thereof;
      (ii) about 0 to about 30 mole % of aromatic and/or aliphatic dicarboxylic acid residues having up to 20 carbon atoms;
   (b) a glycol component comprising:
      (i) about 10 to about 50 mole % of 2,2,4,4-tetramethyl-1,3-cyclobutanediol residues;
      (ii) about 50 to about 90 mole % residues of 1,4-cyclohexanedimethanol;
wherein the total mole % of the dicarboxylic acid component of the final polyester is 100 mole % and
wherein the total mole % of the glycol component of the final polyester is 100 mole %; and
(2) residues comprising titanium atoms and zinc atoms, and less than 30 ppm, or less than 20 ppm, or less than 10 ppm, or less than 5 ppm, or less than 2 ppm, or from 0 to 30 ppm, or from 0 to 20 ppm, or from 0 to 10 ppm, or 0 ppm of tin atoms.
wherein the inherent viscosity is from 0.35 to 0.75 dL/g, or 0.40 to 0.75, or 0.45 to 0.75 dL/g, as determined in 60/40 (wt/wt) phenol/tetrachloroethane at a concentration of 0.5 g/100 ml at 25° C.; and having a b* value of less than 20, of less than 15, or less than 14, or less than 13, or less than 12, or less than 11, or less than 10, or less than 9, or less than 8.5, or less than 8, or less than 7, or less than 6, or less than 5, or from 1 to 10, or from 1 to 9, or from 1 to 8, or from 1 to 7, or from 1 to 6, or from 1 to 5, or from 2 to 6; and an L* value of from 70 to 95 or from 75 to 90, as determined by the L*a*b* color system of the CIE (International Commission on Illumination). In some embodiments, the a* value can also be less than 7, or less than 4, or less than 3, or less than 2, or less than 1, or less than 0, or less than −1, or less than −1.5, or less than −2.

In one embodiment, for all of the polyesters and/or the polyester compositions of the invention, the inherent viscosity can be from 0.35 to 1.2 dL/g, or from 0.35 to 0.80 dL/g, or from 0.35 to 0.75 dL/g, or from 0.35 to 0.70 dL/g, or from 0.35 to 0.60 dL/g, or from 0.40 to 0.75 dL/g, or from 0.40 to 0.70 dL/g, or from 0.40 to 0.65 dL/g, or from 0.40 to 0.60 dL/g, or from 0.45 to 0.75 dL/g, or from 0.45 to 0.70 dL/g, or from 0.45 to 0.65 dL/g, or from 0.45 to 0.60 dL/g, or from 0.50 to 1.2 dL/g, or from 0.50 to 0.80 dL/g, or from 0.50 to 0.75 dL/g, or from 0.50 to 0.70 dL/g, or from 0.50 to 0.65 dL/g, or from 0.50 to 0.60 dL/g, or from 0.55 to 0.75 dL/g, or from 0.55 to 0.70 dL/g, or from 0.60 to 0.75 dL/g, as determined in 60/40 (wt/wt) phenol/tetrachloroethane at a concentration of 0.5 g/100 ml at 25° C.

For the desired polyester, the molar ratio of cis/trans 2,2,4,4-tetramethyl-1,3-cyclobutanediol can vary from the pure form of each and mixtures thereof. In certain embodiments, the molar percentages for cis and/or trans 2,2,4,4-tetramethyl-1,3-cyclobutanediol are greater than 50 mole % of cis-2,2,4,4-tetramethyl-1,3-cyclobutanediol and less than 50 mole % of trans-2,2,4,4-tetramethyl-1,3-cyclobutanediol, or greater than 70 mole % of cis-2,2,4,4-tetramethyl-1,3-cyclobutanediol and less than 30 mole % of trans-2,2,4,4-tetramethyl-1,3-cyclobutanediol, or greater than 75 mole % of cis-TMCD and less than 25 mole % of trans-TMCD; or greater than 80 mole % of cis-TMCD and less than 20 mole % of trans-TMCD; or greater than 85 mole % of cis-TMCD and less than 15 mole % of trans-TMCD; or greater than 90 mole % of cis-2,2,4,4-tetramethyl-1,3-cyclobutanediol and less than 10 mole % of trans-2,2,4,4-tetramethyl-1,3-cyclobutanediol, or greater than 95 mole % of cis-2,2,4,4-tetramethyl-1,3-cyclobutanediol and less than 5 mole % of trans-2,2,4,4-tetramethyl-1,3-cyclobutanediol.

In an additional embodiment, the molar ratio of cis/trans 2,2,4,4-tetramethyl-1,3-cyclobutanediol can vary within the range of 50/50 to 0/100, for example, between 40/60 to 20/80.

In one embodiment, the polyesters and/or the polyester compositions of the invention can comprise 1,4-cyclohexanedimethanol. In another embodiment, the polyesters and/or the polyester compositions of the invention can comprise 1,4-cyclohexanedimethanol and 1,3-cyclohexanedimethanol. The molar ratio of cis/trans 1,4-cyclohexanedimethanol can vary within the range of 50/50 to 0/100, for example, between 40/60 to 20/80.

In some embodiments, the polyesters and/or the polyester compositions of the invention can comprise from 0 to 10 mole percent, for example, from 0.01 to 5 mole percent, from 0.01 to 1 mole percent, from 0.05 to 5 mole percent, from 0.05 to 1 mole percent, or from 0.1 to 0.7 mole percent, based the total mole percentages of either the diol or diacid residues; respectively, of one or more residues of a branching monomer, also referred to herein as a branching agent, having 3 or more carboxyl substituents, hydroxyl substituents, or a combination thereof. In certain embodiments, the branching monomer or agent may be added prior to and/or during and/or after the polymerization of the polyester. In embodiments, the polyester(s) useful in the invention can thus be linear or branched.

Examples of branching monomers include, but are not limited to, multifunctional acids or multifunctional alcohols such as trimellitic acid, trimellitic anhydride, pyromellitic dianhydride, trimethylolpropane, glycerol, pentaerythritol, citric acid, tartaric acid, 3-hydroxyglutaric acid and the like. In one embodiment, the branching monomer residues can comprise 0.1 to 0.7 mole percent of one or more residues chosen from at least one of the following: trimellitic anhydride, pyromellitic dianhydride, glycerol, sorbitol, 1,2,6-hexanetriol, pentaerythritol, trimethylolethane, and/or trimesic acid. The branching monomer may be added to the polyester reaction mixture or blended with the polyester in the form of a concentrate as described, for example, in U.S. Pat. Nos. 5,654,347 and 5,696,176, whose disclosure regarding branching monomers is incorporated herein by reference.

The polyesters and/or polyester compositions of the invention can comprise at least one chain extender. Suitable chain extenders include, but are not limited to, multifunctional (including, but not limited to, bifunctional) isocyanates, multifunctional epoxides, including for example epoxylated novolacs, and phenoxy resins. In certain embodiments, chain extenders may be added at the end of the polymerization process or after the polymerization process. If added after the polymerization process, chain extenders can be incorporated by compounding or by addition during conversion processes such as injection molding or extrusion. The amount of chain extender used can vary depending on the specific monomer composition used and the physical properties desired but is generally about 0.1 percent by weight to about 10 percent by weight, such as about 0.1 to about 5 percent by weight, relative to the mass of the final polyester.

In one embodiment, certain polyesters and/or polyester compositions useful in this invention can be visually clear. The term “visually clear” is defined herein as an appreciable absence of cloudiness, haziness, and/or muddiness, when inspected visually.

In one embodiment, the polyesters useful in the invention and/or the polyester compositions of the invention, [in one embodiment, in the presence of and/or in the absence of toner(s)], can have color values L*, a* and b* which can be determined using a Hunter Lab Ultrascan Spectra Colorimeter manufactured by Hunter Associates Lab Inc., Reston, Va. The color determinations are averages of values measured on either pellets of the polyesters or plaques or other items injection molded or extruded from them. They are determined by the L*a*b* color system of the CIE (International Commission on Illumination) (translated), wherein L* represents the lightness coordinate, a* represents the red/green coordinate, and b* represents the yellow/blue coordinate.

In one embodiment, the phosphorus compound(s) can be an organic compound such as, for example, a phosphorus acid ester containing halogenated or non-halogenated organic substituents. In certain embodiments, the phosphorus compound(s) can comprise a wide range of phosphorus compounds, for example, phosphines, phosphites, phosphinites, phosphonites, phosphinates, phosphonates, phosphine oxides, and phosphates.

Examples of phosphorus compounds that may be useful in the invention can include tributyl phosphate, triethyl phosphate, tri-butoxyethyl phosphate, t-butylphenyl diphenyl phosphate, 2-ethylhexyl diphenyl phosphate, ethyl dimethyl phosphate, isodecyl diphenyl phosphate, trilauryl phosphate, triphenyl phosphate, tricresyl phosphate, trixylenyl phosphate, t-butylphenyl diphenylphosphate, resorcinol bis(diphenyl phosphate), tribenzyl phosphate, phenyl ethyl phosphate, trimethyl thionophosphate, phenyl ethyl thionophosphate, dimethyl methylphosphonate, diethyl methylphosphonate, diethyl pentylphosphonate, dilauryl methylphosphonate, diphenyl methylphosphonate, dibenzyl methylphosphonate, diphenyl cresylphosphonate, dimethyl cresylphosphonate, dimethyl methylthionophosphonate, phenyl diphenylphosphinate, benzyl diphenylphosphinate, methyl diphenylphosphinate, trimethyl phosphine oxide, triphenyl phosphine oxide, tribenzyl phosphine oxide, 4-methyl diphenyl phosphine oxide, triethyl phosphite, tributyl phosphite, trilauryl phosphite, triphenyl phosphite, tribenzyl phosphite, phenyl diethyl phosphite, phenyl dimethyl phosphite, benzyl dimethyl phosphite, dimethyl methylphosphonite, diethyl pentylphosphonite, diphenyl methylphosphonite, dibenzyl methylphosphonite, dimethyl cresylphosphonite, methyl dimethylphosphinite, methyl diethylphosphinite, phenyl diphenylphosphinite, methyl diphenylphosphinite, benzyl diphenylphosphinite, triphenyl phosphine, tribenzyl phosphine, and methyl diphenyl phosphine. In one embodiment, triphenyl phosphine oxide is excluded as a thermal stabilizer in the process(es) of making the polyesters of the invention and/or in the polyester composition(s) of the invention.

In one embodiment, phosphorus compounds useful in the invention can be any of the previously described phosphorus-based acids wherein one or more of the hydrogen atoms of the acid compound (bonded to either oxygen or phosphorus atoms) are replaced with alkyl, branched alkyl, substituted alkyl, alkyl ethers, substituted alkyl ethers, alkyl-aryl, alkyl-substituted aryl, aryl, substituted aryl, and mixtures thereof. In another embodiment, phosphorus compounds useful in the invention, include but are not limited to, the above described compounds wherein at least one of the hydrogen atoms bonded to an oxygen atom of the compound is replaced with a metallic ion or an ammonium ion.

The esters can contain alkyl, branched alkyl, substituted alkyl, alkyl ethers, aryl, and/or substituted aryl groups. The esters can also have at least one alkyl group and at least one aryl group. The number of ester groups present in the particular phosphorus compound can vary from zero up to the maximum allowable based on the number of hydroxyl groups present on the phosphorus compound used. For example, an alkyl phosphate ester can include one or more of the mono-, di-, and tri alkyl phosphate esters; an aryl phosphate ester includes one or more of the mono-, di-, and tri aryl phosphate esters; and an alkyl phosphate ester and/or an aryl phosphate ester also include, but are not limited to, mixed alkyl aryl phosphate esters having at least one alkyl and one aryl group.

In one embodiment, the phosphorus compounds useful in the invention include but are not limited to alkyl, aryl or mixed alkyl aryl esters or partial esters of phosphoric acid, phosphorus acid, phosphinic acid, phosphonic acid, or phosphonous acid. The alkyl or aryl groups can contain one or more substituents.

In one embodiment, the phosphorus compounds useful in the invention comprise at least one phosphorus compound chosen from at least one of substituted or unsubstituted alkyl phosphate esters, substituted or unsubstituted aryl phosphate esters, substituted or unsubstituted mixed alkyl aryl phosphate esters, diphosphites, salts of phosphoric acid, phosphine oxides, and mixed aryl alkyl phosphites, reaction products thereof, and mixtures thereof. The phosphate esters include esters in which the phosphoric acid is fully esterified or only partially esterified.

In one embodiment, for example, the phosphorus compounds useful in the invention can include at least one phosphate ester.

In one embodiment, the phosphorus compounds useful in the invention comprise at least one phosphorus compound chosen from at least one of substituted or unsubstituted alkyl phosphate esters, substituted or unsubstituted aryl phosphate esters, substituted or unsubstituted mixed alkyl aryl phosphate esters, reaction products thereof, and mixtures thereof. The phosphate esters include esters in which the phosphoric acid is fully esterified or only partially esterified.

In one embodiment, for example, the phosphorus compounds useful in the invention can include at least one phosphate ester.

In another embodiment, the phosphate esters useful in the invention can include but are not limited to alkyl phosphate esters, aryl phosphate esters, mixed alkyl aryl phosphate esters, and/or mixtures thereof.

In certain embodiments, the phosphate esters useful in the invention are those where the groups on the phosphate ester include are alkyl, alkoxy-alkyl, phenyl, or substituted phenyl groups. These phosphate esters are generally referred to herein as alkyl and/or aryl phosphate esters. Certain preferred embodiments include trialkyl phosphates, triaryl phosphates, alkyl diaryl phosphates, dialkyl aryl phosphates, and mixtures of such phosphates, wherein the alkyl groups are preferably those containing from 2 to 12 carbon atoms, and the aryl groups are preferably phenyl.

Representative alkyl and branched alkyl groups are preferably those containing from 1-12 carbon atoms, including, but not limited to, ethyl, propyl, isopropyl, butyl, hexyl, cyclohexyl, 2-ethylhexyl, octyl, decyl and dodecyl. Substituted alkyl groups include, but are not limited to, those containing at least one of carboxylic acid groups and esters thereof, hydroxyl groups, amino groups, keto groups, and the like.

Representative of alkyl-aryl and substituted alkyl-aryl groups are those wherein the alkyl portion contains from 1-12 carbon atoms, and the aryl group is phenyl or substituted phenyl wherein groups such as alkyl, branched alkyl, aryl, hydroxyl, and the like are substituted for hydrogen at any carbon position on the phenyl ring. Preferred aryl groups include phenyl or substituted phenyl wherein groups such as alkyl, branched alkyl, aryl, hydroxyl and the like are substituted for hydrogen at any position on the phenyl ring.

In one embodiment, the phosphate esters useful in the invention include but are not limited to dibutylphenyl phosphate, triphenyl phosphate, tricresyl phosphate, tributyl phosphate, tri-2-ethylhexyl phosphate, trioctyl phosphate, and/or mixtures thereof, including particularly mixtures of tributyl phosphate and tricresyl phosphate, and mixtures of isocetyl diphenyl phosphate and 2-ethylhexyl diphenyl phosphate.

In one embodiment, at least one phosphorus compound useful in the invention comprises at least one aryl phosphate ester.

In one embodiment, at least one phosphorus compound useful in the invention comprises at least one unsubstituted aryl phosphate ester.

In one embodiment, at least one phosphorus compound useful in the invention comprises at least one aryl phosphate ester which is not substituted with benzyl groups.

In one embodiment, any of the phosphorus compounds useful in the invention may comprise at least one alkyl phosphate ester.

In one embodiment, the phosphate esters useful in the invention as thermal stabilizers and/or color stabilizers include but are not limited to, at least one of the following: trialkyl phosphates, triaryl phosphates, alkyl diaryl phosphates, and mixed alkyl aryl phosphates.

In one embodiment, the phosphate esters useful in the invention as thermal stabilizers and/or color stabilizers include but are not limited to, at least one of the following: triaryl phosphates, alkyl diaryl phosphates, and mixed alkyl aryl phosphates.

In one embodiment, the phosphate esters useful as thermal stabilizers and/or color stabilizers in the invention can include but are not limited to, at least one of the following: triaryl phosphates and mixed alkyl aryl phosphates.

In one embodiment, at least one phosphorus compound useful in the invention can comprise, but is not limited to, triaryl phosphates, such as, for example, triphenyl phosphate. In one embodiment, at least one thermal stabilizer comprises, but is not limited to Merpol A. In one embodiment, at least one thermal stabilizer useful in the invention comprises, but is not limited to, at least one of triphenyl phosphate and Merpol A. Merpol A is a phosphate ester commercially available from Stepan Chemical Co and/or E.I. duPont de Nemours & Co. The CAS Registry number for Merpol A is believed to be CAS Registry #37208-27-8.

In one embodiment, any of the phosphorus compounds useful in the invention may comprise at least one triaryl phosphate ester which is not substituted with benzyl groups.

In one embodiment, the polyester compositions and/or processes of the invention may comprise 2-ethylhexyl diphenyl phosphate.

In one embodiment, any of the processes described herein for making any of the polyester compositions and/or polyesters can comprise at least one mixed alkyl aryl phosphite, such as, for example, bis(2,4-dicumylphenyl)pentaerythritol diphosphite also known as Doverphos S-9228 (Dover Chemicals, CAS #15486243-8).

In one embodiment, any of the processes described herein for making any of the polyester compositions and/or polyesters can comprise at least one one phosphine oxide.

In one embodiment, any of the processes described herein for making any of the polyester compositions and/or polyesters can comprise at least one salt of phosphoric acid such as, for example, KH2PO4 and Zn3(PO4)2.

The term “thermal stabilizer” is intended to include the reaction product(s) thereof. The term “reaction product” as used in connection with the thermal stabilizers of the invention refers to any product of a polycondensation or esterification reaction between the thermal stabilizer and any of the monomers used in making the polyester as well as the product of a polycondensation or esterification reaction between the catalyst and any other type of additive.

In one embodiment of the invention, the phosphorus compounds useful in the invention may act as thermal stabilizers. In one embodiment of the invention, the phosphorus compounds useful in the invention may not act as a thermal stabilizer but may act as a color stabilizer. In one embodiment of the invention, the phosphorus compounds useful in the invention may act as both a thermal stabilizer and a color stabilizer.

In one embodiment, amounts of the phosphate ester of the invention added during polymerization are chosen from the following: 10 to 200 ppm relative to the mass of the final polyester composition and as measured in the form of phosphorus atoms in the final polyester. In embodiments of the invention, phosphorous can be present in an amount of 10 to 100, or 10 to 80, or 10 to 60, or 10 to 55, or 15 to 55, or 18 to 52, or 20 to 50 ppm, relative to the mass of the final polyester composition and as measured in the form of phosphorus atoms in the final polyester.

In one embodiment, the catalyst system contains at least one titanium compound. In one embodiment, the titanium compound can be used in either the esterification reaction or the polycondensation reaction or both reactions. In one embodiment, the catalyst system contains at least one titanium compound used in the esterification reaction. In one embodiment, the catalyst system contains residues of at least one titanium compound used in the polycondensation reaction.

The titanium-containing compounds useful in this invention include any compound containing titanium including but not limited to at least one of titanium carbonate, titanium acetate, titanium benzoate, titanium succinate, titanium isopropoxide, titanium methoxide, titanium oxalate, titanium nitrate, titanium ethoxide, titanium hydroxide, titanium hydride, titanium glycoxide, alkyl titanium, titanium zinc hydride, titanium borohydride, titanium oxide, titanium acetylacetonate oxide, titanium tri-isopropoxide chloride, titanium bis(acetylacetonate)di-isopropoxide, titanium n-butoxide, titanium tert-butoxide.

In one embodiment, the polyesters and/or polyester compositions of the invention comprise at least one titanium source selected from titanium dioxide, titanium isopropoxide, titanium acetylacetonate oxide, titanium bis(acetylacetonate)di-isopropoxide and/or combinations thereof.

In one embodiment, the catalyst mixture contains at least one zinc compound. In one embodiment, the zinc compound can be used in either the esterification reaction or the polycondensation reaction or both reactions. In one embodiment, the catalyst system contains at least one zinc compound used in the esterification reaction. In one embodiment, the catalyst mixture contains at least one zinc compound used in the polycondensation reaction.

In one embodiment, the polyester compositions can comprise at least one zinc source which is catalytically active. These zinc compounds can include zinc compounds with at least one organic substituent.

Suitable examples of zinc compounds can comprise at least one the carboxylic acid salts of zinc. Examples of zinc can comprise at least one zinc source is selected from zinc borate, zinc oxide, zinc naphthenate, zinc tert-butoxide, zinc methoxide, zinc hydroxide, zinc acetate, zinc diacetate, zinc dihydrate, zinc octoate, zinc carbonate, dialkyl zinc, dimethyl zinc, diaryl zinc (diphenyl zinc), zinc isopropoxide, zinc phosphate, and/or zinc acetylacetonate.

In one embodiment, the polyesters and/or polyester compositions of the invention can comprise at least one zinc source selected from zinc acetylacetonate and zinc isopropoxide.

In one embodiment, the polyesters and/or polyester compositions of the invention can comprise at least one zinc source selected from zinc acetylacetonate.

In one aspect, zinc acetate and/or zinc acetate dihydrate and/or zinc naphthenate, and/or zinc carbonate, and/or residues thereof are not present.

In one embodiment, the polyesters and/or polyester compositions of the invention can comprise titanium atoms in the amount of from 20 to 750 ppm, or from 20 to 500 ppm, or from 20 to 450 ppm, or from 20 to 400 ppm, or from 20 to 350 ppm, or from 20 to 300 ppm, or from 20 to 275 ppm, or from 20 to 250 ppm, or from 20 to 200 ppm, or from 50 to 1000 ppm, or from 50 to 750 ppm, or from 50 to 500 ppm, or from 50 to 450 ppm, or from 50 to 400 ppm, or from 50 to 300 ppm, or from 50 to 275 ppm, or from 50 to 250 ppm, or from 50 to 200 ppm, or from 60 to 1000 ppm, or from 60 to 750 ppm, or from 60 to 500 ppm, or from 60 to 450 ppm, or from 60 to 400 ppm, or from 60 to 350 ppm, or from 60 to 300 ppm, or from 60 to 275 ppm, or from 60 to 250 ppm, or from 60 to 200 ppm, or from 60 to 150 ppm, or from 60 to 100 ppm, or from 75 to 1000 ppm, or from 75 to 750 ppm, or from 75 to 500 ppm, or from 75 to 450 ppm, or from 75 to 400 ppm, or from 75 to 350 ppm, or from 75 to 300 ppm, or from 75 to 250 ppm, or from 75 to 200 ppm, or from 70 to 100 ppm, or from 70 to 90 ppm, or from 65 to 100 ppm, or from 65 to 90 ppm or from 80 to 1000 ppm, or from 80 to 750 ppm, or from 80 to 500 ppm, or from 80 to 450 ppm, or from 80 to 400 ppm, or from 80 to 350 ppm, or from 80 to 300 ppm, or from 80 to 275 ppm, or from 80 to 250 ppm, or from 80 to 200 ppm, or from 100 to 1000 ppm, or from 100 to 750 ppm, or from 100 to 500 ppm, or from 100 to 450 ppm, or from 100 to 400 ppm, or from 100 to 350 ppm, or from 100 to 300 ppm, or from 100 to 275 ppm, or from 100 to 250 ppm, or from 100 to 200, or from 150 to 1000 ppm, or from 150 to 750 ppm, or from 150 to 500 ppm, or from 150 to 450 ppm, or from 150 to 400 ppm, or from 150 to 350 ppm, or from 150 to 300 ppm, or from 150 to 250 ppm, or from 200 to 1000 ppm, or from 200 to 750 ppm, or from 200 to 500 ppm, or from 200 to 450 ppm, or from 200 to 400 ppm, or from 200 to 350 ppm, or from 200 to 300 ppm, or from 200 to 250 ppm, relative to the mass of final polyester being prepared.

In one embodiment, the polyesters and/or polyester compositions of the invention can comprise zinc atoms in the amount of from 50 to 1000 ppm, or from 50 to 750 ppm, or from 50 to 500 ppm, or from 50 to 450 ppm, or from 50 to 400 ppm, or from 50 to 300 ppm, or from 50 to 275 ppm, or from 50 to 250 ppm, or from 50 to 200 ppm, or from 60 to 1000 ppm, or from 60 to 750 ppm, or from 60 to 500 ppm, or from 60 to 450 ppm, or from 60 to 400 ppm, or from 60 to 350 ppm, or from 60 to 300 ppm, or from 60 to 275 ppm, or from 60 to 250 ppm, or from 60 to 200 ppm, or from 60 to 150 ppm, or from 60 to 100 ppm, or from 75 to 1000 ppm, or from 75 to 750 ppm, or from 75 to 500 ppm, or from 75 to 450 ppm, or from 75 to 400 ppm, or from 75 to 350 ppm, or from 75 to 300 ppm, or from 75 to 250 ppm, or from 75 to 200 ppm, or from 70 to 100 ppm, or from 70 to 90 ppm, or from 65 to 100 ppm, or from 65 to 90 ppm or from 80 to 1000 ppm, or from 80 to 750 ppm, or from 80 to 500 ppm, or from 80 to 450 ppm, or from 80 to 400 ppm, or from 80 to 350 ppm, or from 80 to 300 ppm, or from 80 to 275 ppm, or from 80 to 250 ppm, or from 80 to 200 ppm, or from 100 to 1000 ppm, or from 100 to 750 ppm, or from 100 to 500 ppm, or from 100 to 450 ppm, or from 100 to 400 ppm, or from 100 to 350 ppm, or from 100 to 300 ppm, or from 100 to 275 ppm, or from 100 to 250 ppm, or from 100 to 200, or from 150 to 1000 ppm, or from 150 to 750 ppm, or from 150 to 500 ppm, or from 150 to 450 ppm, or from 150 to 400 ppm, or from 150 to 350 ppm, or from 150 to 300 ppm, or from 150 to 250 ppm, or from 200 to 1000 ppm, or from 200 to 750 ppm, or from 200 to 500 ppm, or from 200 to 450 ppm, or from 200 to 400 ppm, or from 200 to 350 ppm, or from 200 to 300 ppm, or from 200 to 250 ppm, relative to the mass of final polyester being prepared.

In one embodiment, the polyesters and/or polyester compositions of the invention are provided wherein the total catalyst metal atoms present in the composition is in the range of from 150 to 800 ppm, or from 150 to 725 ppm, or from 150 to 700 ppm, or from 150 to 500 ppm, or from 150 to 450 ppm, or from 150 to 400 ppm, or from 150 to 300 ppm, 200 to 800 ppm, or from 200 to 725 ppm, or from 200 to 700 ppm, or from 200 to 600 ppm, or from 200 to 500 ppm, or from 200 to 450 ppm, or from 200 to 400 ppm, or from 200 to 300 ppm, or from 250 to 800 ppm, or from 250 to 725 ppm, or from 250 to 700 ppm, or from 250 to 500 ppm, or from 250 to 450 ppm, or from 250 to 400 ppm, or from 300 to 800 ppm, or from 300 to 725 ppm, or from 300 to 700 ppm, or from 300 to 500 ppm, or from 300 to 450 ppm, or from 300 to 400 ppm, or from 350 to 800 ppm, or from 350 to 725 ppm, or from 350 to 700 ppm, or from 350 to 500 ppm, or from 350 to 450 ppm, relative to the mass of final polyester.

In one embodiment, polyesters and/or polyester compositions of the invention are provided wherein the ratio of titanium atoms to zinc atoms in ppm relative to the mass of final polyester being prepared can be from 0.50-1:5 to 5:1, or from 0.50-1:4 to 4:1, or from 0.50-1:3 to 3:1, or from 0.50:1 to 1:5, or from 0.50-1 to 1:4, or from 0.60-1:5 to 5:1, or from 0.60-1:4 to 4:1, or from 0.60-1:3 to 3:1, or from 0.60:1 to 1:5, or from 0.60-1 to 1:4, or from 0.70-1:5 to 5:1, or from 0.70-1:4 to 4:1, or from 0.70-1:3 to 3:1, or from 0.70-1:2 to 2:1, or from 0.70-1.2 to 1:4, or from 0.75-1:5 to 5:1, or from 0.75-1.2 to 1:4 to 4:1, or from 0.75-1:3 to 3:1, or 1:3 to 3:1, 1:3 to 3:1, or from 0.75-1:2 to 2:1, or from 0.75-1.0 to 1:4, or from 0.80:1.2 to 1:4, or from 1.0 to 1.5:1.0 to 1:7.1, or from 1.0 to 1.5:1.0 to 3, or from 1.0 to 1.5:1.0 to 2, or from 1.0 to 1.5:1.0 to 2.5, or from (0.80-1):5 to 5:1, or from 1:5 to 5:1, or from (0.80-1.2):4 to 4:1, or from 1:4 to 4:1, or from (0.80-1):3 to 3:1, or from 1:3 to 3:1, or from (0.80-1):2 to 2:1, 1:2 to 2:1, or from (1-1.3):(1-1.3), or from (1-1.25):(1-1.25).

In one embodiment, polyesters and/or polyester compositions of the invention are provided wherein the ratio of titanium atoms to zinc atoms in ppm relative to the mass of final polyester being prepared can be from 1:5 to 5:1, 1:4 to 4:1, or from 1:3 to 3:1, or from 1-2 to 2:1.

In one embodiment, suitable catalysts for use in the processes of the invention to make the polyesters useful in the invention include at least one titanium compound and one zinc compound. In certain embodiments, other catalysts could possibly be used in the invention in combination with the at least one titanium compound and the at least one zinc compound. Other catalysts may include, but are not limited to, those based on antimony, cobalt, magnesium, germanium.

In one embodiment, the polyesters and/or polyester compositions of the invention can comprise less than 30 ppm, or less than 20 ppm, or less than 10 ppm, or less than 5 ppm, or less than 2 ppm, or from 0 to 30 ppm, or from 0 to 20 ppm, or from 0 to 10 ppm, or 0 ppm tin atoms.

In one embodiment, the polyesters and/or polyester compositions of the invention can comprise less than less than 30 ppm, or less than 20 ppm, or less than 10 ppm, or less than 5 ppm, or less than 2 ppm, or from 0 to 30 ppm, or from 0 to 20 ppm, or from 0 to 10 ppm, or 0 ppm of manganese atoms.

In one embodiment, the polyesters and/or polyester compositions of the invention can comprise less than 30 ppm, or less than 20 ppm, or less than 10 ppm, or less than 5 ppm, or less than 2 ppm, or from 0 to 30 ppm, or from 0 to 20 ppm, or from 0 to 10 ppm, or 0 ppm of cobalt atoms.

In one embodiment, the polyesters and/or polyester compositions of the invention can comprise less than 30 ppm, or less than 20 ppm, or less than 10 ppm, or less than 5 ppm, or less than 2 ppm, or from 0 to 30 ppm, or from 0 to 20 ppm, or from 0 to 10 ppm, or 0 ppm of any of tin atoms and no germanium atoms.

In one embodiment, the polyesters and/or polyester compositions of the invention can comprise less than 30 ppm, or less than 20 ppm, or less than 10 ppm, or less than 5 ppm, or less than 2 ppm, or from 0 to 30 ppm, or from 0 to 20 ppm, or from 0 to 10 ppm, or 0 ppm of any of antimony atoms and/or germanium atoms.

In one embodiment, the polyesters and/or polyester compositions of the invention can comprise less than 30 ppm, or less than 20 ppm, or less than 10 ppm, or less than 5 ppm, or less than 2 ppm, or from 0 to 30 ppm, or from 0 to 20 ppm, or from 0 to 10 ppm, or 0 ppm of any of tin atoms and manganese atoms.

In one embodiment, the polyesters and/or polyester compositions of the invention can comprise less than 30 ppm, or less than 20 ppm, or less than 10 ppm, or less than 5 ppm, or less than 2 ppm, or from 0 to 30 ppm, or from 0 to 20 ppm, or from 0 to 10 ppm, or 0 ppm of any of tin atoms and/or aluminum atoms.

In one embodiment, the polyesters and/or polyester compositions of the invention can comprise less than 30 ppm, or less than 20 ppm, or less than 10 ppm, or less than 5 ppm, or less than 2 ppm, or from 0 to 30 ppm, or from 0 to 20 ppm, or from 0 to 10 ppm, or 0 ppm of any of lithium and/or aluminum atoms.

In one embodiment, the polyesters and/or polyester compositions of the invention can comprise less than 30 ppm, or less than 20 ppm, or less than 10 ppm, or less than 5 ppm, or less than 2 ppm, or from 0 to 30 ppm, or from 0 to 20 ppm, or from 0 to 10 ppm, or 0 ppm of any of tin atoms, lithium, and/or aluminum atoms.

In one embodiment, the polyesters and/or polyester compositions of the invention can comprise less than 30 ppm, or less than 20 ppm, or less than 10 ppm, or less than 5 ppm, or less than 2 ppm, or from 0 to 30 ppm, or from 0 to 20 ppm, or from 0 to 10 ppm, or 0 ppm, of any of the following: tin atoms, and/or manganese atoms, and/or magnesium atoms, and/or germanium atoms, and/or antimony atoms, cobalt atoms, and/or cadmium atoms, and/or calcium atoms, and/or sodium atoms, and/or gallium atoms, and can exclude any combination of these or can exclude all of these.

In one embodiment, the polyesters and/or polyester compositions of the invention can comprise less than 30 ppm, or less than 20 ppm, or less than 10 ppm, or less than 5 ppm, or less than 2 ppm, or from 0 to 30 ppm, or from 0 to 20 ppm, or from 0 to 10 ppm, or 0 ppm of any of the following: tin atoms, manganese atoms, magnesium atoms, germanium atoms, antimony atoms, cobalt atoms, and/or calcium atoms, and can exclude any combination of these or can exclude all of these.

In one embodiment, the polyesters and/or polyester compositions of the invention can comprise less than 30 ppm, or less than 20 ppm, or less than 10 ppm, or less than 5 ppm, or less than 2 ppm, or from 0 to 30 ppm, or from 0 to 20 ppm, or from 0 to 10 ppm, or 0 ppm of any of the following: tin atoms, manganese atoms, lithium atoms, germanium atoms, and cobalt atoms, and can exclude any combination of these or can exclude all of these.

In one embodiment, the polyesters and/or polyester compositions of the invention can comprise less than 30 ppm, or less than 20 ppm, or less than 10 ppm, or less than 5 ppm, or less than 2 ppm, or from 0 to 30 ppm, or from 0 to 20 ppm, or from 0 to 10 ppm, or 0 ppm of gallium atoms.

In one embodiment, the polyesters and/or polyester compositions of the invention can comprise less than 30 ppm, or less than 20 ppm, or less than 10 ppm, or less than 5 ppm, or less than 2 ppm, or from 0 to 30 ppm, or from 0 to 20 ppm, or from 0 to 10 ppm, or 0 ppm of any of sodium atoms and/or potassium atoms.

In certain embodiments of the invention, the Tg of the polyesters and/or polyester compositions a can be chosen from one of the following ranges: from 85 to 130° C., or from 100 to 130° C., or from 100 to 125° C., or from 100 to 120° C. The glass transition temperature (T_{g}) of the polyesters is determined using a TA DSC 2920 from Thermal Analyst Instrument at a scan rate of 20° C./min.

In one embodiment, the polyesters and/or polyester compositions of the invention can have a degree of polymerization of from 0.01 to 300, or 0.01 to 250, or 0.01 to 200, or 0.01 to 150, or 0.01 to 130, or 0.01 to 120, or 0.10 to 300, or 0.10 to 250, or 0.10 to 200, or 0.10 to 150, or 0.10 to 130, or 0.10 to 120, or 0.20 to 300, or 0.20 to 250, or 0.20 to 200, or 0.20 to 150, or 0.20 to 130, or 0.20 to 120, or 0.15 to 300, or 0.15 to 250, or 0.15 to 200, or 0.15 to 150, or 0.15 to 130, or 0.15 to 120.

It is contemplated that compositions useful in the invention can possess at least one of the inherent viscosity ranges described herein and at least one of the monomer ranges for the compositions described herein unless otherwise stated. It is also contemplated that compositions useful in the invention can possess at least one of the T_{g} ranges described herein and at least one of the monomer ranges for the compositions described herein unless otherwise stated. It is also contemplated that compositions useful in the invention can possess at least one of the inherent viscosity ranges described herein, at least one of the T_{g} ranges described herein, and at least one of the monomer ranges for the compositions described herein unless otherwise stated.

The polyester portion of the polyester compositions useful in the invention can be made by processes known from the literature such as, for example, by processes in homogenous solution, by transesterification processes in the melt, and by two phase interfacial processes. Suitable methods include, but are not limited to, the steps of reacting one or more dicarboxylic acids with one or more glycols at a temperature of 100° C. to 315° C. at a pressure of 0.1 to 760 mm Hg for a time sufficient to form a polyester. See U.S. Pat. No. 3,772,405 for methods of producing polyesters, the disclosure regarding such methods is hereby incorporated herein by reference.

The polyester in general may be prepared by condensing the dicarboxylic acid or dicarboxylic acid ester with the glycol in the presence of the titanium catalyst(s) and zinc(s) (and optionally, other catalysts), as described herein, at elevated temperatures increased gradually during the course of the condensation up to a temperature of about 225° C.-310° C., in an inert atmosphere, and conducting the condensation at low pressure during the latter part of the condensation, as described in further detail in U.S. Pat. No. 2,720,507 incorporated herein by reference.

In one embodiment, the invention relates to a process for making a polyester comprising the following steps:
(I) heating a mixture at least one temperature chosen from 150° C. to 300° C., under at least one pressure chosen from the range of 0 psig to 100 psig wherein said mixture comprises:
   (a) a dicarboxylic acid component comprising:
      (i) about 90 to about 100 mole % of terephthalic acid residues;
      (ii) about 0 to about 10 mole % of aromatic and/or aliphatic dicarboxylic acid residues having up to 20 carbon atoms; and
   (b) a glycol component comprising:
      (i) about 10 to about 50 mole % 2,2,4,4-tetramethyl-1,3-cyclobutanediol residues; and
      (ii) about 50 to about 90 mole % of residues of 1,4-cyclohexanedimethanol;
wherein the molar ratio of glycol component/dicarboxylic acid component added in Step (I) is 1.01-3.0/1.0 and wherein TMCD is added in an amount from about 10 to 50 mole %, optionally, to allow for at least 30% conversion of TMCD in the reaction, and to arrive at a final polymer having about 10 to 50 mole % 2,2,4,4-tetramethyl-1,3-cyclobutanediol residues;
wherein the mixture in Step (I) is heated in the presence of:
   (i) at least two catalysts comprising Ti and Zn; and (ii) and, optionally, at least one phosphorus compound;
(II) heating the product of Step (I) at a temperature of 230° C. to 320° C. for 1 to 6 hours, under at least one pressure chosen from the range of the final pressure of Step (I) to 0.02 torr absolute, to form a final polyester;
wherein the total mole % of the dicarboxylic acid component of the final polyester is 100 mole %; and wherein the total mole % of the glycol component of the final polyester is 100 mole %;
wherein the inherent viscosity of the polyester is from 0.35 to 0.80 dL/g as determined in 60/40 (wt/wt) phenol/tetrachloroethane at a concentration of 0.25 g/50 ml at 25° C.; and wherein the L* color values for the polyester is 75 or greater, or greater than 75, as determined by the L*a*b* color system measured following ASTM D 6290-98 and ASTM E308-99, performed on polymer granules ground to pass a 1 mm sieve.

In certain embodiments, the catalyst can comprise less than 30 ppm, or less than 20 ppm, or less than 10 ppm, or less than 5 ppm, or less than 2 ppm, or from 0 to 30 ppm, or from 0 to 20 ppm, or from 0 to 10 ppm, or 0 ppm of tin atoms.

In one embodiment, the polyesters useful in the invention can comprise at least one phosphate ester whether or not present as a thermal stabilizer.

In the processes of the invention, at least one phosphorus compound, for example, at least one phosphate ester, can be added to Step (I), Step (II) and/or Steps (I) and (II) and/or after Steps (I) and/or (II). In certain embodiments, at least one phosphorus compound can be added to only Step (I) or only Step (II).

In embodiments of the invention, at least one phosphorus compound, reaction products thereof, and mixtures thereof can be added either during esterification, polycondensation, or both and/or it can be added post-polymerization. In one embodiment, the phosphorus compound useful in any of the processes of the invention can be added during esterification. In one embodiment, if the phosphorus compound added after both esterification and polycondensation, it is added in the amount of 0 to 2 weight % based on the total weight of the final polyester. In one embodiment, if the phosphorus compound added after both esterification and polycondensation, it is added in the amount of 0.01 to 2 weight %, based on the total weight of the final polyester. In one embodiment, the phosphorus compound can comprise at least one phosphate ester. In one embodiment, the phosphorus compound can comprise at least one phosphorus compound which is added during the esterification step. In one embodiment, the phosphorus compound can comprise at least one phosphate ester, for example, which is added during the esterification step.

It is believed that the processes of making the polyesters described herein may be used to make the polyesters useful in the invention.

Reaction times for the esterification Step (I) of any of the processes of the invention are dependent upon the selected temperatures, pressures, and feed mole ratios of glycol to dicarboxylic acid.

In one embodiment, the pressure used in Step (II) of any of the processes of the invention consists of at least one pressure chosen from 20 torr absolute to 0.02 torr absolute; in one embodiment, the pressure used in Step (II) of any of the processes of the invention consists of at least one pressure chosen from 10 torr absolute to 0.02 torr absolute; in one embodiment, the pressure used in Step (II) of any of the processes of the invention consists of at least one pressure chosen from 5 torr absolute to 0.02 torr absolute; in one embodiment, the pressure used in Step (II) of any of the processes of the invention consists of at least one pressure chosen from 3 torr absolute to 0.02 torr absolute; in one embodiment, the pressure used in Step (II) of any of the processes of the invention consists of at least one pressure chosen from 20 torr absolute to 0.1 torr absolute; in one embodiment, the pressure used in Step (II) of any of the processes of the invention consists of at least one pressure chosen from 10 torr absolute to 0.1 torr absolute; in one embodiment, the pressure used in Step (II) of any of the processes of the invention consists of at least one pressure chosen from 5 torr absolute to 0.1 torr absolute; in one embodiment, the pressure used in Step (II) of any of the processes of the invention consists of at least one pressure chosen from 3 torr absolute to 0.1 torr absolute.

In one embodiment, the molar ratio of glycol component/dicarboxylic acid component added in Step (I) of a process of the invention is 1.0-2.0/1.0; in one embodiment, the molar ratio of glycol component/dicarboxylic acid component added in Step (I) of a process of the invention is 1.01-2.0/1.0; in one embodiment, the molar ratio of glycol component/dicarboxylic acid component added in Step (I) of a process of the invention is 1.01-1.75/1.0; in one embodiment, the molar ratio of glycol component/dicarboxylic acid component added in Step (I) of a process of the invention is 1.01-1.7/1.0; in one embodiment, the molar ratio of glycol component/dicarboxylic acid component added in Step (I) of a process of the invention is 1.01-1.5/1.0; in one embodiment, the molar ratio of glycol component/dicarboxylic acid component added in Step (I) of a process of the invention is 1.01-1.2/1.0.

In embodiments of the invention for the process for making the polyesters, the heating time of Step (II) may be from 1 to 5 hours or 1 to 4 hours or 1 to 3 hours or 1.5 to 3 hours or 1 to 2 hours. In one embodiment, the heating time of Step (II) can be from 1.5 to 3 hours.

In one embodiment, the polyesters, polyester compositions and/or processes of the invention useful in the invention can comprise titanium atoms, zinc atoms, and optionally, phosphorus atoms.

The invention further relates to the polyester compositions made by the process(es) described above.

In embodiments of the invention, certain agents which colorize the polymer can be added to the melt. In one embodiment, a bluing toner is added to the melt in order to reduce the b* of the resulting polyester polymer melt phase product. Such bluing agents include blue inorganic and organic toner(s). In addition, red toner(s) can also be used to adjust the a* color. Organic toner(s), e.g., blue and red organic toner(s), such as those toner(s) described in U.S. Pat. Nos. 5,372,864 and 5,384,377, which are incorporated by reference in their entirety, can be used. The organic toner(s) can be fed as a premix composition. The premix composition may be a neat blend of the red and blue compounds or the composition may be pre-dissolved or slurried in one of the polyester's raw materials, e.g., ethylene glycol.

The total amount of toner components added can depend on the amount of inherent yellow color in the base polyester and the efficacy of the toner. In one embodiment, a concentration of up to about 15 ppm of combined organic toner components and a minimum concentration of about 0.5 ppm are used. In one embodiment, the total amount of bluing additive can range from 0.5 to 10 ppm. In an embodiment, the toner(s) can be added to the esterification zone or to the polycondensation zone. Preferably, the toner(s) are added to the esterification zone or to the early stages of the polycondensation zone, such as to a prepolymerization reactor.

The invention further relates to a polymer blend. The blend comprises:
(a) from 5 to 95 weight % of at least one of the polyesters described above; and
(b) from 5 to 95 weight % of at least one of the polymeric components, based on the total weight of the polymer blend equaling 100 mole %.

Suitable examples of the polymeric components include, but are not limited to, nylon; polyesters different than those described herein such as PET; polyamides such as ZYTEL® from DuPont; polystyrene; polystyrene copolymers; styrene acrylonitrile copolymers; acrylonitrile butadiene styrene copolymers; poly(methylmethacrylate); acrylic copolymers; poly(ether-imides) such as ULTEM® (a poly(ether-imide) from General Electric); polyphenylene oxides such as poly(2,6-dimethylphenylene oxide) or poly(phenylene oxide)/polystyrene blends such as NORYL 1000® (a blend of poly(2,6-dimethylphenylene oxide) and polystyrene resins from General Electric); polyphenylene sulfides; polyphenylene sulfide/sulfones; poly(ester-carbonates); polycarbonates such as LEXAN® (a polycarbonate from General Electric); polysulfones; polysulfone ethers; and poly(ether-ketones) of aromatic dihydroxy compounds; or mixtures of any of the foregoing polymers. The blends can be prepared by conventional processing techniques known in the art, such as melt blending or solution blending.

In one embodiment, the final polyesters and/or polyester compositions of the invention can be blended with recycled poly(ethylene terephthalate) (rPET).

In embodiments, the polyester compositions and the polymer blend compositions can also contain from 0.01 to 25% by weight of the overall composition common additives such as colorants, toner(s), dyes, mold release agents, flame retardants, plasticizers, nucleating agents, stabilizers, including but not limited to, UV stabilizers, thermal stabilizers other than the phosphorus compounds describe herein, and/or reaction products thereof, fillers, and impact modifiers. Examples of commercially available impact modifiers include, but are not limited to, ethylene/propylene terpolymers, functionalized polyolefins such as those containing methyl acrylate and/or glycidyl methacrylate, styrene-based block copolymeric impact modifiers, and various acrylic core/shell type impact modifiers. Residues of such additives are also contemplated as part of the polyester composition.

Reinforcing materials may be added to the compositions of this invention. The reinforcing materials may include, but are not limited to, carbon filaments, silicates, mica, clay, talc, titanium dioxide, Wollastonite, glass flakes, glass beads and fibers, and polymeric fibers and combinations thereof. In one embodiment, the reinforcing materials include glass, such as, fibrous glass filaments, mixtures of glass and talc, glass and mica, and glass and polymeric fibers.

In one embodiment, the polyester compositions are useful in shaped articles, including, but not limited to, extruded, and/or molded articles including, but not limited to, injection molded articles, extruded articles, cast extrusion articles, profile extrusion articles, melt spun articles, thermoformed articles, extrusion molded articles, injection blow molded articles, injection stretch blow molded articles, extrusion blow molded articles and extrusion stretch blow molded articles. These articles can include, but are not limited to, films, bottles, containers, drinkware, medical parts, sheet and/or fibers.

In one embodiment, the invention is related to thermoformed film(s) and/or sheet(s) comprising the polyester(s) and/or polyester compositions of the invention.

In one embodiment, the invention is related to articles of manufacture which incorporate the thermoformed film and/or sheet of the invention.

In one embodiment, the invention relates to the film(s) and/or sheet(s) comprising the polyester compositions and/or polymer blends of the invention. The methods of forming the polyesters and/or blends into film(s) and/or sheet(s) are well known in the art. Examples of film(s) and/or sheet(s) of the invention including but not limited to extruded film(s) and/or sheet(s), compression molded film(s) and/or sheet(s), solution casted film(s) and/or sheet(s). Methods of making film and/or sheet include but are not limited to extrusion, compression molding, and solution casting.

Examples of potential articles made from film and/or sheet useful in the invention include, but are not limited, to thermoformed sheet, graphic arts film, outdoor signs, ballistic glass, skylights, coating(s), coated articles, painted articles, shoe stiffeners, laminates, laminated articles, medical packaging, general packaging, and/or multiwall films or sheets.

In one embodiment, the invention relates to injection molded articles comprising the polyester compositions and/or polymer blends of the invention. Injection molded articles can include injection stretch blow molded bottles, sun glass frames, lenses, sports bottles, drinkware, food containers, medical devices and connectors, medical housings, electronics housings, cable components, sound dampening articles, cosmetic containers, wearable electronics, toys, promotional goods, appliance parts, automotive interior parts, and consumer houseware articles.

In embodiments of the invention, certain polyesters and/or polyester compositions of the invention can have a unique combination of all of the following properties: certain notched Izod impact strength, certain inherent viscosities, certain glass transition temperature (Tg), certain flexural modulus, good clarity, and good color.

The process can be carried out in either a batch or continuous process. In one embodiment, the process is carried out in a continuous process.

In one embodiment, the invention also relates to an article of manufacture made with any of the polyesters and/or polyester compositions described herein.

Because of the long crystallization half-times (e.g., greater than 5 minutes) at 170° C. exhibited by certain polyesters useful in the present invention, it can be possible to produce articles, including but not limited to, injection molded parts, injection blow molded articles, injection stretch blow molded articles, extruded film, extruded sheet, extrusion blow molded articles, extrusion stretch blow molded articles, and fibers. A thermoformable sheet is an example of an article of manufacture provided by this invention. The polyesters of the invention can be amorphous or semicrystalline. In one embodiment, certain polyesters useful in the invention can have relatively low crystallinity. Certain polyesters useful in the invention can thus have a substantially amorphous morphology, meaning that the polyesters comprise substantially unordered regions of polymer.

In any of the polyesters, polyester compositions and/or processes of the invention, the b* color for any given polyester of the invention can either remain stable at a certain inherent viscosity or decreases less than 20%, or less than 15%, or less than 10%, or less than 5%, when additional zinc and/or additional titanium is added or is present, as determined by the L*a*b* color system of the CIE (International Commission on Illumination).

In certain embodiments, the b* values for the polyesters and/or polyester compositions of the invention can be from −10 to less than 20; or from −10 to less than 18; or from −10 to less than 15; or from −10 to less than 14; or from −10 to less than 10; or from 1 to less than 20; or from 1 to less than 18; or from 5 to less than 20; or from 5 to less than 18; or from 8 to less than 20; or from 8 to less than 18; or from 8 to less than 15; or from −3 to 10; or from −5 to 5; or from −5 to 4; or from −5 to 3; or from 1 to 20; or from 1 to 18; or from 1 to 15; or from 1 to 14; or 1 to less than 10; or from 1 to 10; or from 1 to 9; or from 1 to 8; from 1 to 7; or from 1 to 6; or from 1 to 5; or from 2 to 25; or from 2 to 20; or from 2 to 18; or from 2 to 15; or from 2 to 14; or from 2 to less than 10; or from 2 to 9; or from 2 to 8; or from 2 to 7; or from 2 to 6; or from 2 to 5; or from 3 to 20; or from 3 to 18; or from 3 to 15; or from 3 to 14; or from 3 to less than 10; or from 3 to 8; or from 3 to less than 20; or less than 15; or less than 14; or less than 13; or less than 12; or less than 11; or less than 10; or less than 9; or less than 8.5; or less than 8; or less than 7; or less than 6; or less than 5; or less than 4; or less than 3; as determined by the L*a*b* color system of the CIE (International Commission on Illumination).

In certain embodiments, the polyesters and/or polyester compositions of the invention can have an L* value of from 50 to 99, or from 50 to 90, or from 60 to 99, or from 60 to 90, or from 60 to 85, or from 60 to 80, or from 60 to 75, or from 60 to 70, or from 65 to 99, or from 65 to 90, or from 65 to 85, or from 65 to 80, or from 65 to 75, or from 70 to 90, or from 70 to 99, or from 70 to 90, or from 70 to 85, or from 70 to 80, or from 75 to 95, or from 77 to 90, or from 75 to 90, or from 75 to 85, or from 80 to 95, or from 80 to 90, as determined by the L*a*b* color system of the CIE (International Commission on Illumination).

In one embodiment, the b* and/or L* and/or a*values can be obtained in the presence of and/or in the absence of toner(s).

In any of the processes or polyesters or polyester compositions of the invention, the b* color for any given polyester of the invention can either remain stable at a certain inherent viscosity or can decrease less than 20%, or less than 15%, or less than 10%, or less than 5%, when additional zinc is added and/or when additional titanium is added, as determined by the L*a*b* color system of the CIE (International Commission on Illumination).

Notched Izod impact strength, as described in ASTM D256 is a common method of measuring toughness. In one embodiment, the polyesters and/or polyester compositions of the invention can have a notched Izod impact strength of at least 1 ft-lb/inch, or at least 2 ft-lbs/inch, or at least 3 ft-lbs/inch, or 7.5 ft-lbs/in, or 10 ft-lbs/in at 23° C. according to ASTM D256 with a 10-mil notch in a ⅛-inch thick bar.

Notched Izod impact strength is measured herein at 23° C. with a 10-mil notch in a 3.2 mm (⅛-inch) thick bar determined according to ASTM D256. In one embodiment, certain polyesters and/or polyester compositions of the invention can exhibit a notched Izod impact strength of at least 25 J/m (0.47 ft-lb/in) at 23° C. with a 10-mil notch in a 3.2 mm (⅛-inch) thick bar determined according to ASTM D256. In one embodiment, certain polyesters and/or polyester compositions of the invention can exhibit a notched Izod impact strength of from about 25 J/m (0.47 ft-lb/in) to about 75 J/m (1.41 ft-lb/in) at 23° C. with a 10-mil notch in a 3.2 mm (⅛-inch) thick bar determined according to ASTM D256. In another embodiment, certain polyesters and/or polyester compositions of the invention can exhibit a notched Izod impact strength of from about 50 J/m (0.94 ft-lb/in) to about 75 J/m (1.41 ft-lb/in) at 23° C. with a 10-mil notch in a 3.2 mm (⅛-inch) thick bar determined according to ASTM D256.

In one embodiment, certain polyesters and/or polyester compositions of the invention can exhibit at least one of the following densities: a density of greater than 1.2 g/ml at 23° C.

In one embodiment, certain polyesters and/or polyester compositions of the invention useful in the invention can exhibit useful thermal stability of not more than 0.20 dL/g loss in inherent viscosity, or not more than 0.15 dL/g loss in inherent viscosity, or not more than 0.12 dL/g loss in inherent viscosity, or not more than 0.10 dL/g loss in inherent viscosity when heated at 300° C. for over 2.5 hours, where inherent viscosity is determined in 60/40 (wt/wt) phenol/tetrachloroethane at a concentration of 0.5 g/100 ml at 25° C.

In one embodiment, certain polyesters and/or polyester compositions of the invention can exhibit a flexural modulus at 23° C. equal to or greater than 2000 MPa (290,000 psi) as defined by ASTM D790. In another embodiment, certain polyesters useful in the invention can exhibit a tensile strength at 23° C. from about 2000 MPa (290,000 psi) to about 2551 MPa (370,000 psi) as defined by ASTM D638. In another embodiment, certain polyesters useful in the invention can exhibit a flexural modulus at 23° C. from about 2000 MPa (290,000 psi) to about 2413 MPA (350,000 psi) as defined by ASTM D790.

In one embodiment, certain polyesters and/or polyester compositions of the invention can exhibit a flexural modulus at 23° C. equal to or greater than 2000 MPa (290,000 psi) as defined by ASTM D790. In another embodiment, certain polyesters of the invention can exhibit a tensile strength at 23° C. from about 2000 MPa (290,000 psi) to about 2551 MPa (370,000 psi) as defined by ASTM D638. In another embodiment, certain polyesters of the invention can exhibit a flexural modulus at 23° C. from about 2000 MPa (290,000 psi) to about 2413 MPA (350,000 psi) as defined by ASTM D790.

Certain polyesters and/or polyester compositions of the invention can possess at least one of the following properties: a Tg of from about 85 to about 130° C. as measured by a TA 2100 Thermal Analyst Instrument at a scan rate of 20° C./min; a flexural modulus at 23° C. equal to or greater than 2000 MPa (290,000 psi) as defined by ASTM D790; and a notched Izod impact strength equal to or greater than 25 J/m (0.47 ft-lb/in) according to ASTM D256 with a 10-mil notch using a ⅛-inch thick bar at 23° C.

In certain embodiments, the final polyesters and/or polyester compositions of the invention can comprise methyl groups in the amount of 5.0 mole % or less, or 4.5 mole % or less, or 4 mole % or less, or 3 mole % or less, or 2.5 mole % of less, or 2.0 mole % or less, or 1.5 mole % or less, or 1.0 mole % or less.

It is believed that the processes of making the polyesters described herein may be used to make the polyesters useful in the invention.

It is believed that any of the processes of making the polyesters described herein may be used to make the polyester compositions useful in the invention.

In one embodiment, the invention also relates to a process for making any of the polyesters useful in the invention.

In one embodiment, the invention also relates to a process for making any of the polyester compositions of the invention.

In one embodiment, the invention also relates to a product made by any of the processes described herein.

In one embodiment, the polyesters and/or polyester compositions of the invention can be useful for non-coating compositions, non-adhesive compositions, thermoplastic polyester compositions, articles of manufacture, shaped articles, thermoplastic shaped articles, molded articles, extruded articles, injection molded articles, blow molded articles, film and/or sheet (for example, calendered, cast, or extruded), thermoformed film or sheet, container, or bottle (for example, baby bottles or sports bottles or water bottles).

In one embodiment, the present invention comprises a thermoplastic article, typically in the form of sheet material, having a decorative material embedded therein which comprise any of the compositions described herein.

In one embodiment, the polyesters according to the invention can be used for appliance parts. “Appliance parts,” as used herein, refers to a rigid piece used in conjunction with an appliance. In one embodiment, the appliance part is partly or wholly separable from the appliance. In another embodiment, the appliance part is one that is typically made from a polymer. In one embodiment, the appliance part is visually clear.

In one embodiment, the polyesters according to the invention can be used for bottles and containers including those that are injection molded, injection blow molded, injection stretch blow molded, blow molded, or reheat blow molded. Articles made by these methods include dual wall tumblers, water bottles, sports bottles, bulk water containers, and baby bottles.

The following examples further illustrate how the polyesters of the invention can be made and evaluated, and are intended to be purely exemplary of the invention and are not intended to limit the scope thereof. Unless indicated otherwise, parts are parts by weight, temperature is in degrees C. or is at room temperature, and pressure is at or near atmospheric.

### EXAMPLES

The following examples illustrate, in general, how copolyesters of this invention are prepared and the effect of using 2,2,4,4-tetramethyl-1,3-cyclobutanediol and 1,4-cyclohexanedimethanol, and certain catalyst and stabilizers, on various copolyester properties such as color and inherent viscosity (IV).

### Measurement Methods

The inherent viscosity of the polyesters was determined in 60/40 (wt/wt) phenol/tetrachloroethane at a concentration of 0.5 g/100 ml at 25° C., and is reported in dL/g.

The glycol content and the cis/trans ratio of the compositions were determined by proton nuclear magnetic resonance (NMR) spectroscopy. All NMR spectra were recorded on a JEOL Eclipse Plus 600 MHz nuclear magnetic resonance spectrometer using either chloroform-trifluoroacetic acid (70-30 volume/volume) for polymers or, for oligomeric samples, 60/40 (wt/wt) phenol/tetrachloroethane with deuterated chloroform added for lock. Peak assignments for 2,2,4,4-tetramethyl-1,3-cyclobutanediol resonances were made by comparison to model mono- and dibenzoate esters of 2,2,4,4-tetramethyl-1,3-cyclobutanediol. These model compounds closely approximate the resonance positions found in the polymers and oligomers.

Color values reported herein are CIELAB L*, a*, and b* values measured following ASTM D 6290-98 and ASTM E308-99, using measurements from a Hunter Lab Ultrascan XE Spectrophotometer (Hunter Associates Laboratory Inc., Reston, Va.) with the following parameters: (1) D65 illuminant, (2) 10 degree observer, (3) reflectance mode with specular angle included, (4) large area view, (5) 1″ port size. Unless stated otherwise, the measurements were performed on polymer granules ground to pass a 1 mm sieve.

The amount of titanium (Ti), and zinc (Zn) in the examples below is reported in parts per million (ppm) of metal and was measured by inductively coupled plasma mass spectrometry (ICP). The amount of phosphorous is similarly reported as ppm of elemental phosphorus and was also measured by ICP using the same instrument. The values reported in the column “P measured” in the following examples were obtained by measuring phosphorous as described above.

Unless otherwise specified, the cis/trans ratio of the 2,2,4,4-tetramethyl-1,3-cyclobutanediol used in the following examples was approximately 60/40 and could range from 45/55 to 99/1.

Unless otherwise noted, IV or I.V. is meant to refer to inherent viscosity measured as described herein.

### Preparation of the Copolyesters of Examples 1-45

The process for the preparation of the copolyesters in Examples 1-45 as shown in Table 1 is exemplified by the preparation of the copolyester of Example 38 which a target composition of 100 mole % dimethyl terephthalate residues, 35 mole % TMCD residues, and 65 mole % CHDM residues. A mixture of 77.7 g of dimethyl terephthalate, 37.5 g of CHDM, 25.9 g of TMCD, 0.130 g of zinc acetylacetonate, and 0.077 g of titanium isopropoxide was placed in a 500-milliliter flask equipped with an inlet for nitrogen, a metal stirrer, and a short distillation column. The flask was placed in a Wood's metal bath already heated to 220° C. The stirring speed was set to 175 RPM and this was held for 15 minutes. The contents of the flask were heated to 230° C. over 5 minutes while the stirring was simultaneous raised to 225° C. over that time. The contents were then raised to 245° C. slowly over 45 minutes. The content remained at 245° C. while the pressure was reduced to 250 torr over three minutes. The temperature was again raised to 265° C. over the course of 15 minutes. The pressure was then further reduced to 3.5 torr over the course of eight minutes. Finally, the temperature was increase to 277° C. while the stir rate slowly decreased to 50 RPM and the pressure dropped to 1 torr over the course of 20 minutes. The reaction was held at this final temperature, pressure and stir rate for 35 minutes. A high melt viscosity, visually clear polymer was obtained with an inherent viscosity of 0.62 dl/g. NMR analysis showed that the polymer was composed of 31.47% TMCD residues.

TABLE 1
COPOLYESTERS COMPRISING TMCD, CHDM, AND 100 mole % DMT; Ti and Zn

| | | | | | | | | | | Total | |
|---|---|---|---|---|---|---|---|---|---|---|---|
| | | | | | | | | | | ppm | Methyl |
| | TMCD | CHDM | | | | | | | Ratio | Metal | Groups- |
| Ex | Mol % | Mole % | a* | b* | L* | IV | Ti | Zn | Ti/Zn | Catalyst | Mole % |
| 1 | 29.37 | 70.63 | −0.69 | 10.59 | 81.85 | 0.317 | 80 | 500 | 01:06.2 | 580 | 5.84 |
| 2 | 29.29 | 70.71 | −0.82 | 10.89 | 83.53 | 0.291 | 82 | 500 | 01:06.1 | 582 | 6.85 |
| 3 | 27.71 | 72.29 | −0.48 | 15.61 | 80.32 | 0.291 | 70 | 500 | 01:07.1 | 570 | 6.92 |
| 4 | 29.44 | 70.56 | −0.07 | 12.54 | 80.37 | 0.507 | 89 | 500 | 01:05.6 | 589 | 3.11 |
| 5 | 28.62 | 71.38 | −0.06 | 19.73 | 83.38 | 0.697 | 94 | 500 | 01:05.3 | 594 | 6.35 |
| 6 | 27.94 | 69.7; and | −0.62 | 12.28 | 84.57 | 0.368 | 53 in | 500 | 01:01.9 | 553 | 5.08 |
| | | (2.36 mole | | | | | EG | | | | |
| | | % EG) | | | | | | | | | |
| 7 | 32.25 | 67.75 | −0.15 | 8.65 | 79.78 | 0.66 | 167 | 405 | 01:02.4 | 572 | 2.06 |
| 8 | 33.9 | 66.1 | −0.16 | 8.62 | 79.86 | 0.615 | 638 | 392 | 01:01.5 | 648 | 1.59 |
| 9 | 34.61 | 65.39 | −0.21 | 7 | 81.17 | 0.585 | 329 | 396 | 01:01.2 | 725 | 1.01 |
| 10 | 33.64 | 66.36 | −0.38 | 6.69 | 79.1 | 0.368 | 171 | 117 | 1.46:1 | 288 | 0.94 |
| 11 | 33.12 | 66.88 | −0.27 | 8.89 | 79.56 | 0.3 | 171 | 229 | 01:01.3 | 400 | 0.89 |
| 12 | 33.63 | 66.37 | −0.23 | 8.88 | 77.59 | 0.596 | 173 | 298 | 01:01.7 | 471 | 1.41 |
| 13 | 33.15 | 66.85 | −0.51 | 12.29 | 82.12 | 0.237 | 176 | 400 | 01:02.3 | 576 | 2.2 |
| 14 | 26.78 | 73.22 | 0.5 | 14.67 | 85.62 | 0.207 | 200 | 500 | 01:02.5 | 700 | 11.07 |
| 15 | 29.62 | 70.38 | 2.42 | 17.54 | 78.42 | 0.295 | 200 | 500 | 01:02.5 | 700 | 7.49 |
| 16 | 24.82 | 75.18 | 0.03 | 14.81 | 87.67 | 0.17 | 200 | 500 | 01:02.5 | 700 | 14.23 |
| 17 | 30.88 | 69.12 | 3.46 | 18.89 | 75.7 | 0.334 | 200 | 500 | 01:02.5 | 700 | 6.99 |
| 18 | 35.26 | 64.74 | −0.33 | 2.32 | 77.53 | 0.616 | 341 | 300 | 1.14:1 | 641 | 0.33 |
| 19 | 35.9 | 64.09 | 0.035 | 3.56 | 78.79 | 0.58 | 343 | 300 | 1.14:1 | 643 | 0.25 |
| 20 | 29.52 | 70.48 | −0.05 | 7.45 | 79.38 | 0.49 | 282 | 300 | 1.06:1 | 582 | 4.45 |
| 21 | 34.94 | 65.06 | −0.62 | 5.79 | 76.33 | 0.633 | 384 | 300 | 1.28:1 | 684 | 0.45 |
| 22 | 34.39 | 65.61 | 0.2 | 6.63 | 84.37 | 0.448 | 314 | 379 | 01:01.2 | 693 | 1.02 |
| 23 | 34.2 | 65.8 | −0.12 | 4.64 | 86.93 | 0.481 | 351 | 422 | 01:01.2 | 773 | 0.94 |
| 24 | 33.74 | 66.26 | −0.08 | 5.57 | 85.1 | 0.413 | 252 | 362 | 01:01.4 | 614 | 2.75 |
| 25 | 32.7 | 67.3 | −0.05 | 5.68 | 87.5 | 0.412 | 260 | 372 | 01:01.4 | 632 | 1.85 |
| 26 | 35.49 | 64.51 | 6.85 | 17.85 | 75.2 | 0.424 | 229 | 383 | 01:01.7 | 612 | 5.69 |
| 27 | 34.71 | 65.29 | 4.2 | 17.74 | 75.32 | 0.557 | 231 | 393 | 01:01.7 | 624 | 3.41 |
| 28 | 31.35 | 68.65 | 1.14 | 10.34 | 84.52 | 0.51 | 160 | 200 | 01:01.3 | 360 | 4.39 |
| 29 | 31.82 | 68.18 | 0.1 | 8.29 | 85.02 | 0.527 | 160 | 200 | 01:01.3 | 360 | 3.95 |
| 30 | 32.44 | 67.56 | −0.42 | 6.53 | 84.94 | 0.586 | 160 | 200 | 01:01.3 | 360 | 2.97 |
| 31* | 32.4 | 67.6 | 0.54 | 5.3 | 84.19 | 0.577 | 160 | 200 | 01:01.3 | 360 | 2.91 |
| 32* | 32.94 | 67.06 | 0.49 | 4.85 | 86.78 | 0.55 | 250 | 200 | 1.25:1 | 450 | 2.03 |
| 33* | 33.62 | 66.38 | 0.3 | 5.04 | 88.61 | 0.408 | 250 | 200 | 1.25:1 | 450 | 2.14 |
| 35* | 33.81 | 66.19 | −4.7 | 4.53 | 89.37 | 0.359 | 250 | 200 | 1.25:1 | 450 | 2.63 |
| 36* | 32.05 | 67.95 | −0.82 | 5.38 | 82.04 | 0.511 | 132.1 | 341.7 | 1:2.59 | 473.8 | N/A |
| 37* | 32.54 | 67.46 | −0.67 | 4.83 | 82.65 | 0.532 | 132.6 | 329.6 | 1:2.49 | 462.2 | N/A |
| 38* | 31.47 | 68.53 | −0.79 | 4.66 | 76.62 | 0.62 | 120.3 | 306 | 1:2.54 | 426.3 | N/A |
| 39* | 32.08 | 67.92 | −0.86 | 6.70 | 80.11 | 0.563 | 134.7 | 327.4 | 1:2.43 | 461.1 | N/A |

*Examples 18 and 19 had air exposure; Examples 41-48 were part of a molar ratio study, changing the excess glycol throughout; Examples 20 had added water; Example 21 had added methanol; Examples 22-25, changed final temperature and pressure; Examples 26 and 27, changed molar ratio; Examples 36-39, 36 used 63.41 mole % cis-TMCD, 37 used 61.69 mole % cis-TMCD, 38 used 62.41 mole % cis-TMCD, 39 used 62.42 mole % cis-TMCD.

Early experiments revealed that in tandem, titanium and zinc were capable of significant TMCD incorporation into a polyester resulting in high inherent viscosity. Significant color improvements were observed upon reducing the overall catalyst charge while TMCD incorporation and viscosity build were still very good. Together these results also demonstrated a good range of TMCD incorporation which could be manipulated via the mol-ratio of the glycol charges.

A comparative series of polymers were prepared with a tin and phosphorus catalyst package as shown in Table 2. Similar inherent viscosity, and TMCD conversion were observed when compared to titanium and zinc, however it should be noted that the phosphorus is believed to be needed to bring color values down close to those observed with titanium and zinc.

TABLE 2
Copolyesters Comprising TMCD; CHDM; 100 mole
% DMT; Sn (ppm) and Phosphorus(P) (ppm); [Sn
source is butyltin tris(2-ethylhexanoate)]

| | | Cis- | | | | | | | |
|---|---|---|---|---|---|---|---|---|---|
| Example | TMCD | TMCD | CHDM | | | | IV- | | |
| Number | Mole % | Mole % | Mole % | a* | b* | L* | Inherent | Sn | P |
| 40 | 34.0 | 55/45 | 66.0 | N/A | 1.6 | 80.4 | 0.69 | 159 | 0 |
| 41 | 33.15 | 57.64/42.36 | 66.85 | −0.97 | 3.41 | 84.64 | 0.67 | 111.3 | 6.3 |
| 42 | 33.89 | 56.47/43.53 | 66.11 | −1.07 | 3.54 | 83.41 | 0.672 | 116.2 | 6.6 |
| 43 | 32.95 | 55.99/44.01 | 67.05 | −1.07 | 3.08 | 82.39 | 0.646 | 108 | 7.3 |
| 44 | 34.02 | 56.77 | 65.98 | −0.90 | 3.11 | 82.26 | 0.622 | 90.50 | 6.3 |
| 45 | 34.27 | 57.13 | 65.73 | −1.12 | 4.09 | 81.34 | 0.672 | 107.50 | 8.0 |

It is unpredictable that a Ti/Zn catalyst system compares favorably with the use of a tin catalyst system in obtaining similar good inherent viscosities and similar good color (without the need for phosphorus) as shown in Table 2.

A comparative series of polymers were synthesized with the a tin catalyst. Color, viscosity and TMCD incorporation were observed to be comparable to those provided by the Zn/Ti system described in this work.

Polymers prepared with Zinc and Titanium in combination and in various loadings were observed to compare favorably to TMCD containing polymers prepared with Tin

This disclosure has been described in detail with particular reference to preferred embodiments thereof, but it will be understood that variations and modifications can be effected within the spirit and scope of the disclosure.

1. A polyester composition comprising:
(1) at least one polyester which comprises:
(a) a dicarboxylic acid component comprising:
(i) about 70 to about 100 mole % residues of terephthalic acid or esters thereof;
(ii) about 0 to about 30 mole % of aromatic and/or aliphatic dicarboxylic acid residues having up to 20 carbon atoms;
(b) a glycol component comprising:
(i) about 10 to about 60 mole % of 2,2,4,4-tetramethyl-1,3-cyclobutanediol residues;
(ii) about 40 to about 90 mole % residues of 1,4-cyclohexanedimethanol;
(iii) optionally, residues of at least one modifying glycol;
wherein the total mole % of the dicarboxylic acid component of the final polyester is 100 mole %;
wherein the total mole % of the glycol component of the final polyester is 100 mole %; and
(2) residues comprising titanium atoms and zinc atoms, and less than 30 ppm, or less than 20 ppm, or less than 10 ppm, or less than 5 ppm, or less than 2 ppm, or from 0 to 30 ppm, or from 0 to 20 ppm, or from 0 to 10 ppm, or 0 ppm of tin atoms.

2. The polyester composition of claim 1 wherein said modifying glycol of said polyester comprises at least one of diethylene glycol, 1,2-propanediol, 1,3-propanediol, 2-methyl-1,3-propanediol, 1,4-cyclohexanedimethanol, ethylene glycol, 1,4-butanediol, 1,5-pentanediol, 1,6-hexanediol, p-xylene glycol, neopentyl glycol, isosorbide, polytetramethylene glycol, or mixtures thereof.

3. The polyester composition of claim 1, wherein said polyester comprises residues of 2,2,4,4-tetramethyl-1,3-cyclobutanediol in the amount of from about 20 to about 40 mole %.

4. The polyester composition of claim 3, wherein said polyester comprises 1,4-cyclohexanedimethanol residues in the amount of from about 60 to about 80 mole %.

5. (canceled)

6. The polyester composition of claim 1, wherein the inherent viscosity of said polyester is from 0.25 dL/g to 1.2 dL/g, as determined in 60/40 (wt/wt) phenol/tetrachloroethane at a concentration of 0.5 g/100 ml at 25° C.

7. The polyester composition of claim 1, comprising no manganese atoms and/or no gallium atoms.

8. (canceled)

9. The polyester composition of claim 1, comprising titanium atoms in the amount of from 20 to 1000 ppm, relative to the mass of final polyester being prepared.

10. The polyester composition of claim 1, comprising zinc atoms in the amount of from 50 to 1000 ppm, relative to the mass of final polyester being prepared.

11. The polyester composition of claim 1, wherein the ratio of titanium atoms to zinc atoms in ppm relative to the mass of final polyester being prepared is from 0.50-1:5 to 5:1.

12. The polyester composition of claim 1, wherein the total catalyst metal atoms present in the composition is in the range of from 150 to 800 ppm, relative to the mass of final polyester being prepared.

13. The polyester composition of claim 1, wherein at least one titanium source is selected from at least one of titanium carbonate, titanium acetate, titanium benzoate titanium succinate, titanium isopropoxide, titanium methoxide, titanium oxalate, titanium nitrate, titanium ethoxide, titanium hydroxide, titanium hydride, titanium glycoxide, alkyl titanium, titanium zinc hydride, titanium borohydride, titanium oxide, titanium acetylacetonate oxide, titanium tri-isopropoxide chloride, titanium bis(acetylacetonate)di-isopropoxide, titanium n-butoxide, titanium tert-butoxide.

14. The polyester composition of claim 1, wherein at least one titanium source is selected from titanium dioxide, titanium isopropoxide, titanium acetylacetonate oxide, titanium bis(acetylacetonate)di-isopropoxide and/or combinations thereof.

15. The polyester composition of claim 1, wherein at least one zinc source is selected from zinc borate, zinc oxide, zinc naphthenate, zinc tert-butoxide, zinc methoxide, zinc hydroxide, zinc acetate, zinc diacetate, zinc dihydrate, zinc octoate, zinc carbonate, dialkyl zinc, dimethyl zinc, diaryl zinc, zinc isopropoxide, zinc phosphate, and/or zinc acetylacetonate; or wherein at least one zinc source is selected from zinc acetylacetonate and zinc isopropoxide.

16. The polyester composition of claim 1, wherein said 2,2,4,4-tetramethyl-1,3-cyclobutanediol residues are a mixture comprising greater than 70 mole % of cis-2,2,4,4-tetramethyl-1,3-cyclobutanediol and less than 30 mole % of trans-2,2,4,4-tetramethyl-1,3-cyclobutanediol.

17. The polyester composition of claim 1, wherein said polyester composition comprises at least one polymer chosen from at least one of the following: polyesters other than those in claim 1, poly(etherimides), polyphenylene oxides, poly(phenylene oxide)/polystyrene blends, polystyrene resins, polyphenylene sulfides, polyphenylene sulfide/sulfones, poly(ester-carbonates), polycarbonates, polysulfones; polysulfone ethers, and poly(ether-ketones); or wherein said polyester composition comprises a blend of said polyester with recycled poly(ethylene terephthalate) (rPET).

18. The polyester composition of claim 1, comprising residues of at least one phosphorus compound.

19. The polyester composition of claim 1, comprising methyl groups in the amount of 5.0 mole % or less in the final polyesters and/or polyester compositions of the invention.

20. The polyester composition of claim 1, wherein said polyester has a b* value of less than 6, as determined by the L*a*b* color system of the CIE (International Commission on Illumination); and an inherent viscosity of 0.45 to 0.75 dL/g, as determined in 60/40 (wt/wt) phenol/tetrachloroethane at a concentration of 0.5 g/100 ml at 25° C., and wherein the ratio of titanium atoms to zinc atoms in ppm, relative to the mass of final polyester being prepared, is from 0.80:3 to 3:1.

21. (canceled)

22. The polyester composition of claim 1, wherein the extent of TMCD incorporation or conversion in the final polyester is greater than 55 mole %.

23. An article of manufacture made with the polyester composition of claim 1.
